(19) United States
(12) Patent Application Publication
(10) Pub. No.: US 2023/0164329 A1
(43) Pub. Date: May 25, 2023

(54) VIDEO COMPRESSION APPARATUS, ELECTRONIC APPARATUS, AND VIDEO COMPRESSION PROGRAM

(71) Applicant: NIKON CORPORATION, Tokyo (JP)

(72) Inventor: Masaya TAKAHASHI, Tokyo (JP)

(73) Assignee: NIKON CORPORATION, Tokyo (JP)

(21) Appl. No.: 17/044,050

(22) PCT Filed: Mar. 26, 2019
(86) PCT No.: PCT/JP2019/012886

§ 371 Date: Jan. 5, 2021

(30) Foreign Application Priority Data
Mar. 30, 2018 (JP) 2018-070203

(51) Int. Cl. H04N 19/167; H04N 7/01; H04N 19/172; H04N 19/186; H04N 19/513

(52) U.S. Cl. CPC H04N 19/167; H04N 7/013; H04N 19/172; H04N 19/186; H04N 19/513

(57) ABSTRACT

A video compression apparatus is configured to compress a plurality of frames outputted from an imaging element having a plurality of imaging regions in which a subject is captured and that can set imaging conditions for each of the imaging regions, the video compression apparatus comprising: an acquisition unit configured to acquire data outputted from a first imaging region in which a first frame rate is set and data outputted from a second imaging region in which a second frame rate is set; a generation unit configured to generate a plurality of first frames on the basis of the data outputted from the first imaging region acquired and generate a plurality of second frames on the basis of the data outputted from the second imaging region; and a compression unit configured to compress the plurality of first frames generated and compress the plurality of second frames.

### CLAIM OF PRIORITY

The present application claims priority from Japanese patent application JP 2018-70203 filed on Mar. 30, 2018, the content of which is hereby incorporated by reference into this application.

### BACKGROUND

The present invention pertains to a video compression apparatus, an electronic apparatus, and a video compression program.

Imaging apparatuses provided with imaging elements that can set differing imaging conditions for each region are known (see JP 2006-197192 A). However, video compression of frame captured under differing imaging conditions has not been considered so far.

### SUMMARY

An aspect of the disclosure of a video compression apparatus in this application is a video compression apparatus configured to compress a plurality of frames outputted from an imaging element that has a plurality of imaging regions in which a subject is captured and that can set imaging conditions for each of the imaging regions, the video compression apparatus comprising: an acquisition unit configured to acquire data outputted from a first imaging region in which a first frame rate is set and data outputted from a second imaging region in which a second frame rate is set; a generation unit configured to generate a plurality of first frames on the basis of the data outputted from the first imaging region acquired by the acquisition unit and generate a plurality of second frames on the basis of the data outputted from the second imaging region; and a compression unit configured to compress the plurality of first frames generated by the generation unit and compress the plurality of second frames.

An aspect of the disclosure of an electronic apparatus in this application is an electronic apparatus, comprising: an imaging element having a plurality of imaging regions in which a subject is captured, and that can set imaging conditions for each of the imaging regions; an acquisition unit configured to acquire data outputted from a first imaging region in which a first frame rate is set and data outputted from a second imaging region in which a second frame rate is set; a generation unit configured to generate a plurality of first frames on the basis of the data outputted from the first imaging region acquired by the acquisition unit and generate a plurality of second frames on the basis of the data outputted from the second imaging region; and a compression unit configured to compress the plurality of first frames generated by the generation unit and compress the plurality of second frames.

An aspect of the disclosure of a video compression program in this application is a video compression program that causes a processor to execute compression of a plurality of frames outputted from an imaging element that has a plurality of imaging regions in which a subject is captured and that can set imaging conditions for each of the imaging regions, wherein said program causes the processor to execute: an acquisition process of acquiring data outputted from a first imaging region in which a first frame rate is set and data outputted from a second imaging region in which a second frame rate is set; a generation process of generating a plurality of first frames on the basis of the data outputted from the first imaging region acquired in the acquisition process and generating a plurality of second frames on the basis of the data outputted from the second imaging region; and a compression process of compressing the plurality of first frames generated in the generation process and compressing the plurality of second frames.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a cross-sectional view of a layered the imaging element.

FIG. 2 illustrates the pixel arrangement of the imaging chip.

FIG. 3 is a circuit diagram illustrating the imaging chip.

FIG. 4 is a block diagram illustrating an example of the functional configuration of the imaging element.

FIG. 5 illustrates the block configuration example of an electronic apparatus.

FIG. 6 illustrates the relation between an imaging face and a subject image.

FIG. 7 illustrates a video compression and decompression example according to the illustrative embodiment 1.

FIG. 8 is a descriptive view showing a file format example for video files.

FIG. 9 is a descriptive drawing showing the relationship between the frames and the additional information.

FIG. 10 is a descriptive drawing showing combination process example 1 in the combination unit shown in FIG. 7.

FIG. 11 is a descriptive drawing showing combination process example 2 in the combination unit shown in FIG. 7.

FIG. 12 is a block diagram showing a configuration example of the control unit 502 shown in FIG. 5.

FIG. 13 is a block diagram illustrating the configuration of the compression unit.

FIG. 14 is a sequence diagram illustrating the operation processing procedure example of the control unit.

FIG. 15 is a flowchart illustrating the detailed processing procedure example of the setting process shown in FIG. 14 (Steps S1404 and S1410).

FIG. 16 is a flowchart illustrating the detailed processing procedure example of the frame rate setting process (Step S1505) shown in FIG. 15.

FIG. 17 is a flowchart showing an example of compensation process steps by the first generation unit.

FIG. 18 is a flowchart showing an example of detailed process steps of the video file generation process (steps S1417, S1418) shown in FIG. 14.

FIG. 19 is a flowchart illustrating the compression control process procedure example of the first compression control method by the compression control unit.

FIG. 20 is a flowchart illustrating the motion detection process procedure example of the first compression control method by the motion detection unit.

FIG. 21 is a flowchart illustrating the motion compensation process procedure example of the first compression control method by the motion compensation unit.

FIG. 22 is a flowchart illustrating the compression control process procedure example of the second compression control method by the compression control unit.

FIG. 23 is a flowchart illustrating the motion detection processing procedure example of the second compression control method by the motion detection unit.

FIG. 24 is a flowchart illustrating the motion compensation processing procedure example of the second compression control method by the motion compensation unit.

FIG. 25 is a flowchart showing an example of process steps from decompression to playback.

FIG. 26 is a flowchart showing an example of detailed process steps of the combination process (step S2507) shown in FIG. 25.

FIG. 27 illustrates the flow of the identification processing of the combination process example 1 shown in FIG. 10.

FIG. 28 illustrates the combination example 1of the frame F2 of 60[fps] according to illustrative embodiment 2.

FIG. 29 illustrates the combination example 2 of the frame F2 of 60[fps] according to illustrative embodiment 2.

FIG. 30 illustrates the combination example 4 of the frame F2 of 60[fps] according to illustrative embodiment 2.

FIG. 31 is a flowchart illustrating the combination process procedure example 1 by the combination example 1 of the frame F2 by the combination unit.

FIG. 32 is a flowchart illustrating the combination process procedure example 2 by the combination example 2 of the frame F2 by the combination unit 703.

FIG. 33 is a flowchart illustrating the combination process procedure example 3 by the combination example 3 of the frame F2 by the combination unit 703.

FIG. 34 is a flowchart illustrating the combination process procedure example 4 by the combination example 4 of the frame F2 by the combination unit 703.

FIG. 35 illustrates the combination example of the frame F2 of 60[fps] according to the illustrative embodiment 3.

FIG. 36 illustrates the correspondence between the imaging region setting and the image region of the frame F2-60.

### DETAILED DESCRIPTION OF THE EMBODIMENTS

### Configuration Example of Imaging Element

First, the following section will describe a layered imaging element provided in an electronic apparatus. The electronic apparatus is an imaging apparatus such as a digital camera or a digital video camera.

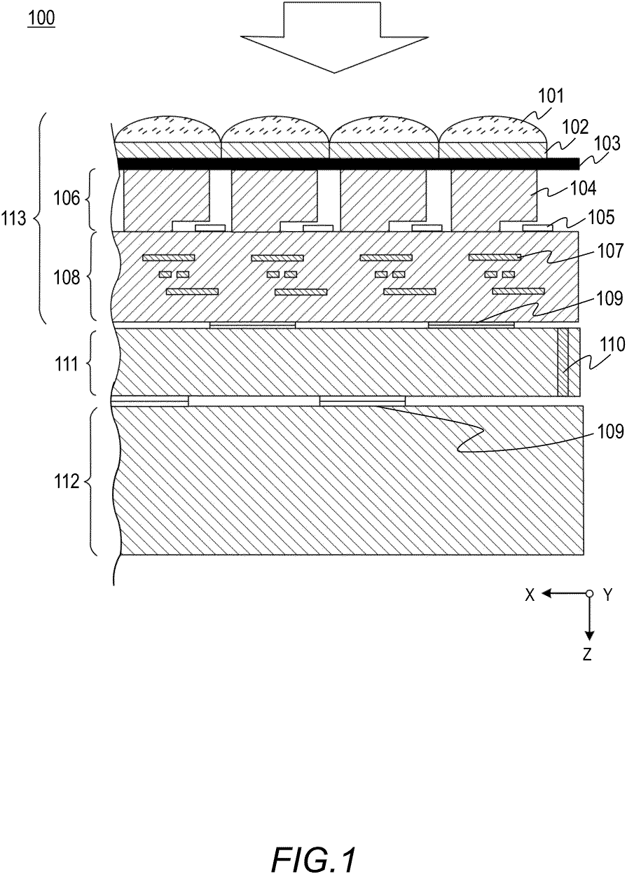

FIG. 1 is a cross-sectional view of a layered the imaging element 100. The layered imaging element (hereinafter simply referred to as “imaging element”) 100 includes a backside illumination-type imaging chip to output a pixel signal corresponding to incident light (hereinafter simply referred to as “imaging chip”) 113, a signal processing chip 111 to process a pixel signal, and a memory chip 112 to store a pixel signal. The imaging chip 113, the signal processing chip 111, and the memory chip 112 are layered and are electrically connected by a bump 109 made of conductive material such as Cu.

As shown in FIG. 1, the incident light is inputted in a positive direction in the Z axis mainly shown by the outlined arrow. In this embodiment, the imaging chip 113 is configured so that a face to which the incident light is inputted is called a back face. As shown by the coordinate axes 120, a left direction orthogonal to Z axis when viewed on the paper is a positive X axis direction and a front direction orthogonal to the Z axis and the X axis when viewed on the paper is a positive Y axis direction. In some of the subsequent drawings, the coordinate axes are shown so as to show the directions of the drawings based on the coordinate axes of FIG. 1 as a reference.

One example of the imaging chip 113 is a backside illumination-type MOS (Metal Oxide Semiconductor) image sensor. A PD (photo diode) layer 106 is provided at the back face side of a wiring layer 108. The PD layer 106 is provided in a two-dimensional manner and has a plurality of PDs 104 in which the electric charge depending on the incident light is accumulated and transistors 105 provided to correspond to the PDs 104.

The side at which the PD layer 106 receives the incident light has color filters 102 via a passivation film 103. The color filters 102 have a plurality of types to allow light to be transmitted through wavelength regions different from one another. The color filters 102 have a specific arrangement corresponding to the respective PDs 104. The arrangement of the color filters 102 will be described later. A combination of the color filter 102, the PD 104, and the transistor 105 constitutes one pixel.

A side at which the color filter 102 receives the incident light has a microlens 101 corresponding to each pixel. The microlens 101 collects the incident light toward the corresponding PD 104.

The wiring layer 108 has a wiring 107 to transmit a pixel signal from the PD layer 106 to the signal processing chip 111. The wiring 107 may have a multi-layer structure or may include a passive element and an active element.

A surface of the wiring layer 108 has thereon a plurality of bumps 109. The plurality of bumps 109 are aligned with a plurality of bumps 109 provided on an opposing face of the signal processing chip 111. The pressurization of the imaging chip 113 and the signal processing chip 111 for example causes the aligned bumps 109 to be bonded to have an electrical connection therebetween.

Similarly, the signal processing chip 111 and the memory chip 112 have therebetween faces opposed to each other that have thereon a plurality of bumps 109. These bumps 109 are mutually aligned and the pressurization of the signal processing chip 111 and the memory chip 112 for example causes the aligned bumps 109 to be bonded to have an electrical connection therebetween.

The bonding between the bumps 109 is not limited to a Cu bump bonding by the solid phase diffusion and may use a micro bump coupling by the solder melting. One bump 109 may be provided relative to one block (which will be described later) for example. Thus, the bump 109 may have a size larger than the pitch of the PD 104. Surrounding regions other than a pixel region in which pixels are arranged may additionally have a bump larger than the bump 109 corresponding to the pixel region.

The signal processing chip 111 has a TSV (silicon through-electrode) 110 to provide the mutual connection among circuits provided on the top and back faces, respectively. The TSV 110 is preferably provided in the surrounding region. The TSV 110 also may be provided in the surrounding region of the imaging chip 113 and the memory chip 112.

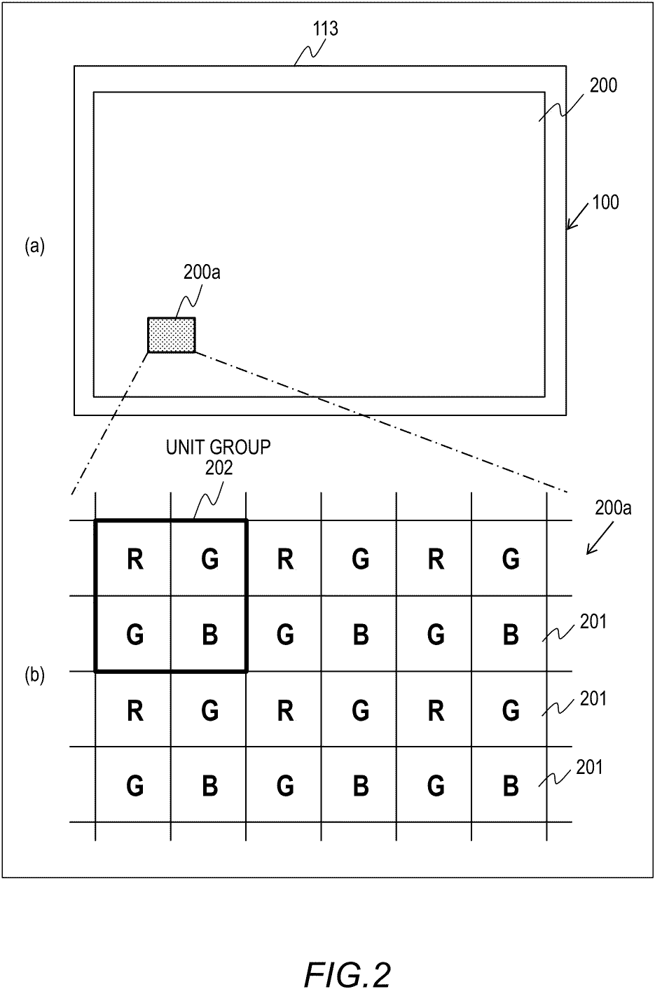

FIG. 2 illustrates the pixel arrangement of the imaging chip 113. In particular, (a) and (b) of FIG. 2 illustrate the imaging chip 113 observed from the back face side. In FIG. 2, (a) of FIG. 2 is a plan view schematically illustrating an imaging face 200 that is a back face of the imaging chip 113. In FIG. 2, (b) of FIG. 2 is an enlarged plan view illustrating a partial region 200a of the imaging face 200. As shown in (b) of FIG. 2, the imaging face 200 has many pixels 201 arranged in a two-dimensional manner.

The pixels 201 have color filter (not shown), respectively. The color filters consist of the three types of red (R), green(G), and blue (B). In (b) of FIG. 2, the reference numerals “R”, “G”, and “B” show the types of color filters owned by the pixels 201. As shown in (b) of FIG. 2, the imaging element 100 has the imaging face 200 on which the pixels 201 including the respective color filters as described above are arranged based on a so-called Bayer arrangement.

The pixel 201 having a red filter subjects red waveband light of the incident light to a photoelectric conversion to output a light reception signal (photoelectric conversion signal). Similarly, the pixel 201 having a green filter subjects green waveband light of the incident light to a photoelectric conversion to output a light reception signal. The pixel 201 having a blue filter subjects blue waveband light of the incident light to a photoelectric conversion to output a light reception signal.

The imaging element 100 is configured so that a block 202 consisting of the total of pixels 201 composed of 2 pixels × 2 pixels adjacent to one another can be individually controlled. For example, when two blocks 202 different from each other simultaneously start the electric charge accumulation, then one block 202 starts the electric charge reading (i.e., the light reception signal reading) after 1/30 seconds from the start of the electric charge accumulation and the another block 202 starts the electric charge reading after 1/15 seconds from the start of the electric charge accumulation. In other words, the imaging element 100 is configured so that one imaging operation can have a different exposure time (or an electric charge accumulation time or a so-called shutter speed) for each block 202.

The imaging element 100 also can set, in addition to the above-described exposure time, an imaging signal amplification factor (a so-called ISO sensibility) that is different for each block 202. The imaging element 100 can have, for each block 202, a different timing at which the electric charge accumulation is started and/or a different timing at which the light reception signal is read. Specifically, the imaging element 100 can have a different video imaging frame rate for each block 202.

In summary, the imaging element 100 is configured so that each block 202 has different imaging conditions such as the exposure time, the amplification factor, or the frame rate. For example, a reading line (not shown) to read an imaging signal from a photoelectric conversion unit (not shown) owned by the pixel 201 is provided for each block 202 and an imaging signal can be read independently for each block 202, thereby allowing each block 202 to have a different exposure time (shutter speed).

An amplifier circuit (not shown) to amplify the imaging signal generated by the electric charge subjected to the photoelectric conversion is independently provided for each block 202. The amplification factor by the amplifier circuit can be controlled independently for each amplifier circuit, thereby allowing each block 202 to have a different signal amplification factor (ISO sensibility).

The imaging conditions that can be different for each block 202 may include, in addition to the above-described imaging conditions, the frame rate, a gain, a resolution (thinning rate), an addition line number or an addition row number to add pixel signals, the electric charge accumulation time or the accumulation number, and a digitization bit number for example. Furthermore, a control parameter may be a parameter in an image processing after an image signal is acquired from a pixel.

Regarding the imaging conditions, the brightness (diaphragm value) of each block 202 can be controlled by allowing the imaging element 100 to include a liquid crystal panel having a zone that can be independently controlled for each block 202 (one zone corresponds to one block 202) so that the liquid crystal panel is used as a light attenuation filter that can be turned ON or OFF for example.

The number of the pixels 201 constituting the block 202 is not limited to the above-described 4 (or 2×2) pixels. The block 202 may have at least one pixel 201 or may include more-than-four pixels 201.

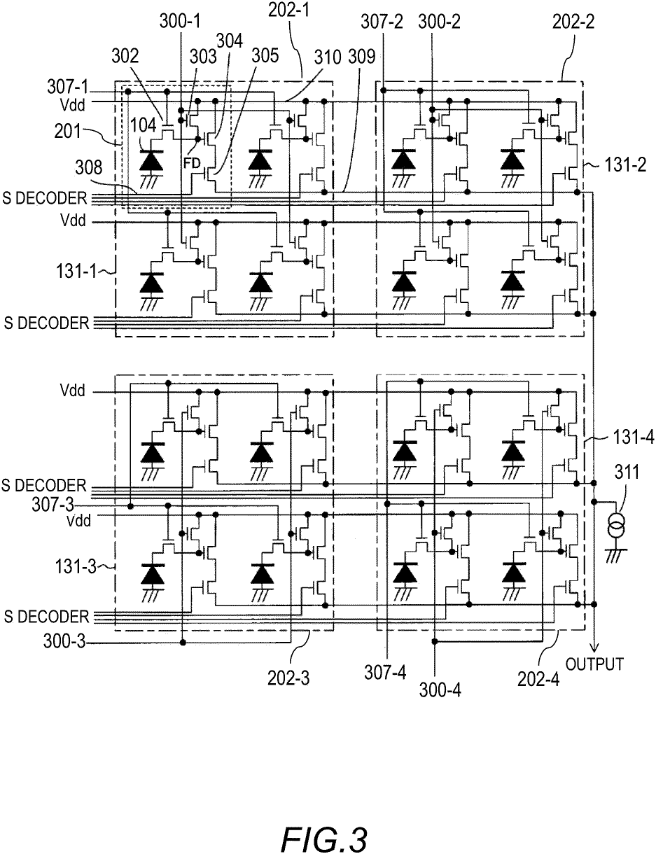

FIG. 3 is a circuit diagram illustrating the imaging chip 113. In FIG. 3, a rectangle shown by the dotted line representatively shows a circuit corresponding to one pixel 201. A rectangle shown by a dashed line corresponds to one block 202 (202-1 to 202-4). At least a part of each transistor described below corresponds to the transistor 105 of FIG. 1.

As described above, the pixel 201 has a reset transistor 303 that is turned ON or OFF by the block 202 as a unit. A transfer transistor 302 of pixel 201 is also turned ON or OFF by the block 202 as a unit. In the example shown in FIG. 3, a reset wiring 300-1 is provided that is used to turn ON or OFF the four reset transistors 303 corresponding to the upper-left block 202-1. A TX wiring 307-1 is also provided that is used to supply a transfer pulse to the four transfer transistors 302 corresponding to the block 202-1.

Similarly, a reset wiring 300-3 is provided that is used to turn ON of OFF the four reset transistors 303 corresponding to the lower-left the block 202-3 so that the reset wiring 300-3 is provided separately from the reset wiring 300-1. A TX wiring 307-3 is provided that is used to supply a transfer pulse to the four transfer transistors 302 corresponding to the block 202-3 so that the TX wiring 307-3 is provided separately from the TX wiring 307-1.

An upper-right block 202-2 and a lower-right block 202-4 similarly have a reset wiring 300-2 and a TX wiring 307-2 as well as a reset wiring 300-4 and a TX wiring 307-4 that are provided in the respective blocks 202.

The 16 PDs 104 corresponding to each pixel 201 are connected to the corresponding transfer transistors 302, respectively. The gate of each transfer transistor 302 receives a transfer pulse supplied via the TX wiring of each block 202. The drain of each transfer transistor 302 is connected to the source of the corresponding reset transistor 303. A so-called floating diffusion FD between the drain of the transfer transistor 302 and the source of the reset transistor 303 is connected to the gate of the corresponding amplification transistor 304.

The drain of each reset transistor 303 is commonly connected to a Vdd wiring 310 to which a supply voltage is supplied. The gate of each reset transistor 303 receives a reset pulse supplied via the reset wiring of each block 202.

The drain of each amplification transistor 304 is commonly connected to the Vdd wiring 310 to which a supply voltage is supplied. The source of each amplification transistor 304 is connected to the drain of the corresponding the selection transistor 305. The gate of each the selection transistor 305 is connected to a decoder wiring 308 to which a selection pulse is supplied. The decoder wirings 308 are provided independently for 16 selection transistors 305, respectively.

The source of each selection transistor 305 is connected to a common output wiring 309. A load current source 311 supplies a current to an output wiring 309. Specifically, the output wiring 309 to the selection transistor 305 is formed by a source follower. It is noted that the load current source 311 may be provided at the imaging chip 113 side or may be provided at the signal processing chip 111 side.

The following section will describe the flow from the start of the accumulation of the electric charge to the pixel output after the completion of the accumulation. A reset pulse is applied to the reset transistor 303 through the reset wiring of each block 202 and a transfer pulse is simultaneously applied the transfer transistor 302 through the TX wiring of each block 202 (202-1 to 202-4). Then, the PD 104 and a potential of the floating diffusion FD are reset for each block 202.

When the application of the transfer pulse is cancelled, each PD 104 converts the received incident light to electric charge to accumulate the electric charge. Thereafter, when a transfer pulse is applied again while no reset pulse is being applied, the accumulated electric charge is transferred to the floating diffusion FD. The potential of the floating diffusion FD is used as a signal potential after the accumulation of the electric charge from the reset potential.

Then, when a selection pulse is applied to the selection transistor 305 through the decoder wiring 308, a variation of the signal potential of the floating diffusion FD is transmitted to the output wiring 309 via the amplification transistor 304 and the selection transistor 305. This allows the pixel signal corresponding to the reset potential and the signal potential to be outputted from the unit pixel to the output wiring 309.

As described above, the four pixels forming the block 202 have common reset wiring and TX wiring. Specifically, the reset pulse and the transfer pulse are simultaneously applied to the four pixels within the block 202, respectively. Thus, all pixels 201 forming a certain block 202 start the electric charge accumulation at the same timing and complete the electric charge accumulation at the same timing. However, a pixel signal corresponding to the accumulated electric charge is selectively outputted from the output wiring 309 by sequentially applying the selection pulse to the respective selection transistors 305.

In this manner, the timing at which the electric charge accumulation is started can be controlled for each block 202. In other words, images can be formed at different timings among different blocks 202.

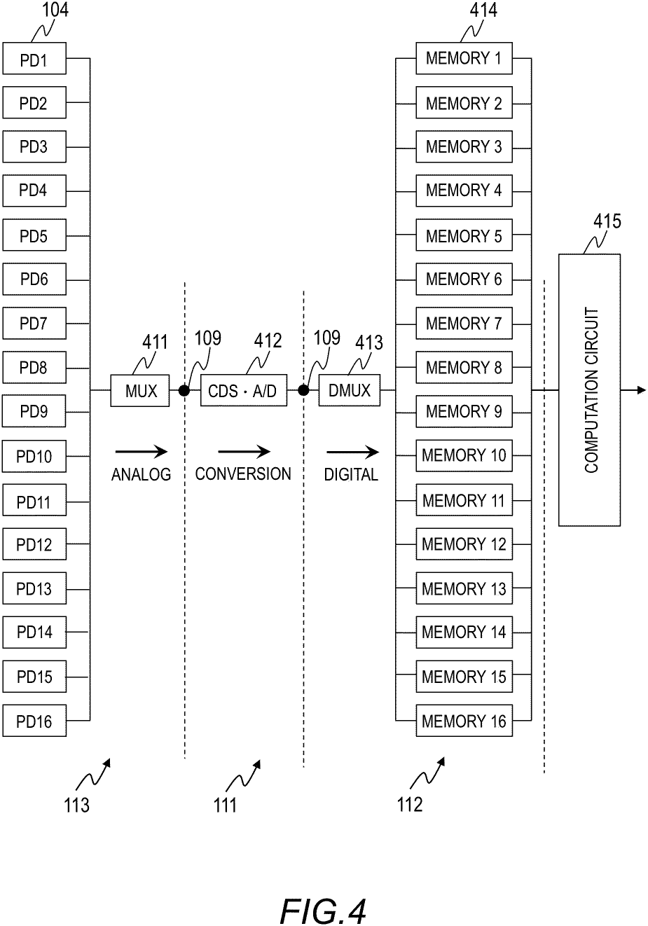

FIG. 4 is a block diagram illustrating an example of the functional configuration of the imaging element 100. An analog multiplexer 411 sequentially selects the sixteen PDs 104 forming the block 202 to output the respective pixel signals to the output wiring 309 provided to correspond to the block 202. The multiplexer 411 is formed in the imaging chip 113 together with the PDs 104.

The pixel signal outputted via the multiplexer 411 is subjected to the correlated double sampling (CDS) and the analog /digital (A/D) conversion performed by the signal processing circuit 412 formed in the signal processing chip 111. The A/D-converted pixel signal is sent to a demultiplexer 413 and is stored in a pixel memory 414 corresponding to the respective pixels. The demultiplexer 413 and the pixel memory 414 are formed in the memory chip 112.

A computation circuit 415 processes the pixel signal stored in the pixel memory 414 to send the result to the subsequent image processing unit. The computation circuit 415 may be provided in the signal processing chip 111 or may be provided in the memory chip 112. It is noted that FIG. 4 shows the connection of the four blocks 202 but they actually exist for each of the four blocks 202 and operate in a parallel manner.

However, the computation circuit 415 does not have to exist for each of the four blocks 202. For example, one computation circuit 415 may provide a sequential processing while sequentially referring to the values of the pixel memories 414 corresponding to the respective four blocks 202.

As described above, the output wirings 309 are provided to correspond to the respective blocks 202. The imaging element 100 is configured by layering the imaging chip 113, the signal processing chip 111, and the memory chip 112. Thus, these output wirings 309 can use the electrical connection among chips using the bump 109 to thereby providing a wiring arrangement without causing an increase of the respective chips in the face direction.

### Block Configuration Example of Electronic Apparatus

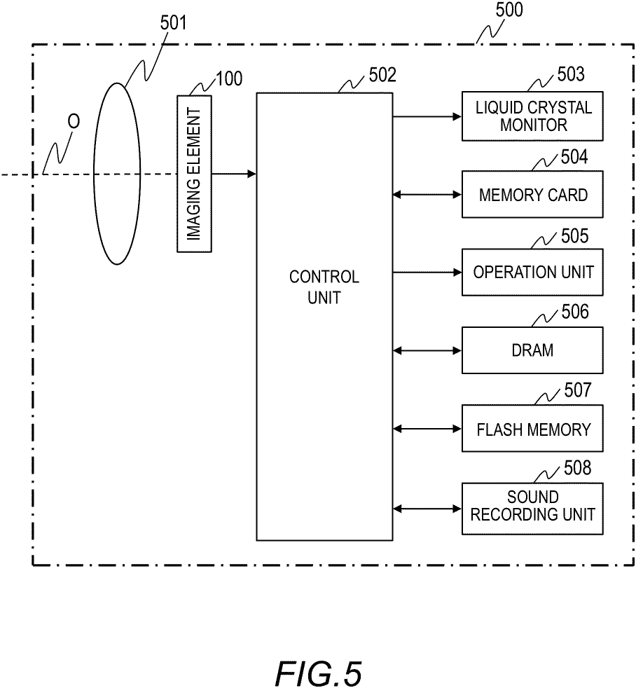

FIG. 5 illustrates the block configuration example of an electronic apparatus. An electronic apparatus 500 is a lens integrated-type camera for example. The electronic apparatus 500 includes an imaging optical system 501, an imaging element 100, a control unit 502, a liquid crystal monitor 503, a memory card 504, an operation unit 505, a DRAM 506, a flash memory 507, and a sound recording unit 508. The control unit 502 includes a compression unit for compressing video data as described later. Thus, a configuration in the electronic apparatus 500 that includes at least the control unit 502 functions as a video compression apparatus, a decompression apparatus or a playback apparatus. Furthermore, a memory card 504, a DRAM 506, and a flash memory 507 constitute a storage device 1202 described later.

The imaging optical system 501 is composed of a plurality of lenses and allows the imaging face 200 of the imaging element 100 to form a subject image. It is noted that FIG. 5 shows the imaging optical system 501 as one lens for convenience.

The imaging element 100 is an imaging element such as a CMOS (Complementary Metal Oxide Semiconductor) or a CCD (Charge Coupled Device) and images a subject image formed by the imaging optical system 501 to output an imaging signal. The control unit 502 is an electronic circuit to control the respective units of the electronic apparatus 500 and is composed of a processor and a surrounding circuit thereof.

The flash memory 507, which is a nonvolatile storage medium, includes a predetermined control program written therein in advance. A processor in the control unit 502 reads the control program from the flash memory 507 to execute the control program to thereby control the respective units. This control program uses, as a work area, the DRAM 506 functioning as a volatile storage medium.

The liquid crystal monitor 503 is a display apparatus using a liquid crystal panel. The control unit 502 allows, at a predetermined cycle (e.g., 60/1 seconds), the imaging element 100 to form a subject image repeatedly. Then, the imaging signal outputted from the imaging element 100 is subjected to various image processings to prepare a so-called through image to display the through image on the liquid crystal monitor 503. The liquid crystal monitor 503 displays, in addition to the above through image, a screen used to set imaging conditions for example.

The control unit 502 prepares, based on the imaging signal outputted from the imaging element 100, an image file (which will be described later) to record the image file on the memory card 504 functioning as a portable recording medium. The operation unit 505 has various operation units such as a push button. The operation unit 505 outputs, depending on the operation of these operation members, an operation signal to the control unit 502.

The sound recording unit 508 is composed of a microphone for example and converts the environmental sound to an acoustic signal to input the resultant signal to the control unit 502. It is noted that the control unit 502 may record a video file not in the memory card 504 functioning as a portable recording medium but in a recording medium (not shown) included in the electronic apparatus 500 such as a hard disk or a solid state drive (SSD) .

### Relation Between the Imaging Face and the Subject Image

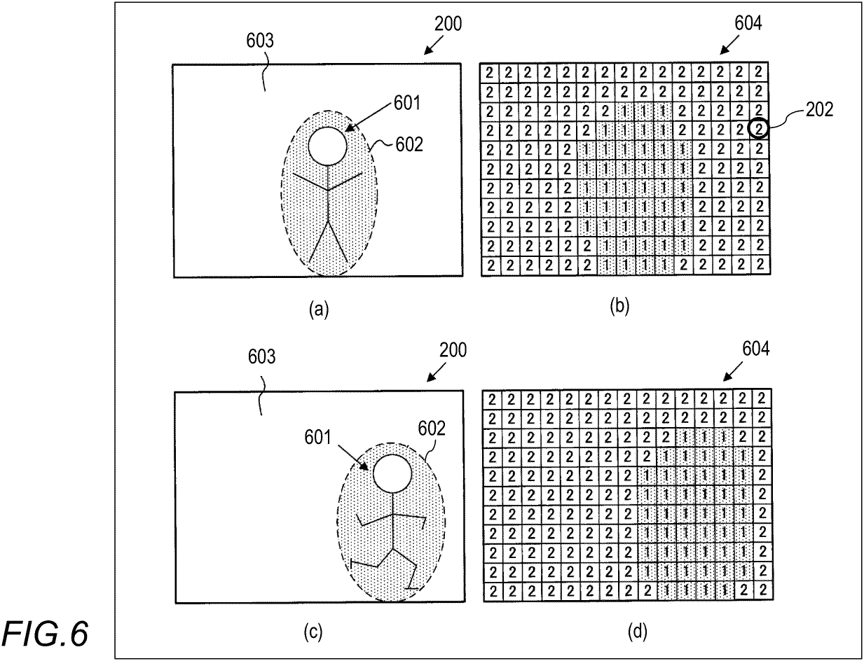

FIG. 6 illustrates the relation between an imaging face and a subject image. In FIG. 6, (a) of FIG. 6 is a schematic view illustrating the imaging face 200 (imaging range) of the imaging element 100 and a subject image 601. In (a) of FIG. 6, the control unit 502 images the subject image 601. The imaging operation of (a) of FIG. 6 also may be used as an imaging operation performed to prepare a live view image (a so-called through image).

The control unit 502 subjects the subject image 601 obtained by the imaging operation of (a) of FIG. 6 to a predetermined image analysis processing. The image analysis processing is a processing to use a well-known subject detection technique (a technique to compute a feature quantity to detect a range in which a predetermined subject exists) for example to detect a main subject region. In the first embodiment, a region other than a main subject is a background. A main subject is detected by the image analysis processing, which causes the imaging face 200 to be divided to a main subject region 602 including a main subject and a background region 603 including the background.

It is noted that (a) of FIG. 6 shows that a region approximately including the subject image 601 is shown as the main subject region 602. However, the main subject region 602 may have a shape formed along the external form of the subject image 601. Specifically, the main subject region 602 may be set so as not to include images other than the subject image 601.

The control unit 502 sets different imaging conditions for each block 202 in the main subject region 602 and each block 202 in the background region 603. For example, a precedent block 202 is set to have a higher shutter speed than that of a subsequent block 202. This suppresses, in the imaging operation of (c) of FIG. 6 after the imaging operation of (a) of FIG. 6, the main subject region 602 from having image blur.

The control unit 502 is configured, when the influence by a light source such as sun existing in the background region 603 causes the main subject region 602 to have a backlight status, to set the block 202 of the former to have a relatively-high ISO sensibility or a lower shutter speed. The control unit 502 is also configured to set the block 202 of the latter to have a relatively-low ISO sensibility or a higher shutter speed. This can prevent, in the imaging operation of (c) of FIG. 6, the black defect of the main subject region 602 in the backlight status and the blown out highlights of the background region 603 having a high light quantity.

It is noted that the image analysis processing may be a processing different from the above-described processing to detect the main subject region 602 and the background region 603. For example, this processing may be a processing to detect a part of the entire imaging face 200 that has a brightness equal to or higher than a certain value (a part having an excessively-high brightness) or that has a brightness lower than the than a certain value (a part having an excessively-low brightness). When the image analysis processing is such a processing, the control unit 502 may set the shutter speed and/or the ISO sensibility so that the block 202 included in the former region has an exposure value (Ev value) lower than that of the block 202 included in another region.

The control unit 502 sets the shutter speed and/or the ISO sensibility so that the block 202 included in the latter region has an exposure value (Ev value) higher than that of the block 202 included in another region. This can consequently allow an image obtained through the imaging operation of (c) of FIG. 6 to have a dynamic range wider than the original dynamic range of the imaging element 100.

In FIG. 6, (b) of FIG. 6 shows one example of mask information 604 corresponding to the imaging face 200 shown in (a) of FIG. 6. The position of the block 202 belonging to the main subject region 602 stores therein “1” and the position of the block 202 belonging to the background region 603 stores therein “2”, respectively.

The control unit 502 subjects the image data of the first frame to the image analysis processing to detect the main subject region 602 and the background region 603. This allows, as shown in (c) of FIG. 6, the frame obtained by the imaging operation of (a) of FIG. 6 to be divided to the main subject region 602 and the background region 603. The control unit 502 sets different imaging conditions for each block 202 in the main subject region 602 and each block 202 in the background region 603 to perform the imaging operation of (c) of FIG. 6 to prepare image data. An example of the resultant mask information 604 is shown in (d) of FIG. 6.

The mask information 604 of (b) of FIG. 6 corresponding to the imaging result of (a) of FIG. 6 and the mask information 604 of (d) of FIG. 6 corresponding to the imaging result of (c) of FIG. 6 are obtained by the imaging operations performed at different times (or have a time difference). Thus, these two pieces of the mask information 604 have different contents when the subject has moved or the user has moved the electronic apparatus 500. In other words, the mask information 604 is dynamic information changing with the time passage. Thus, a certain block 202 has different imaging conditions set for the respective frames.

The following section will describe an illustrative embodiment of the above-described video compression using the imaging element 100.

### Video Compression and Decompression Example

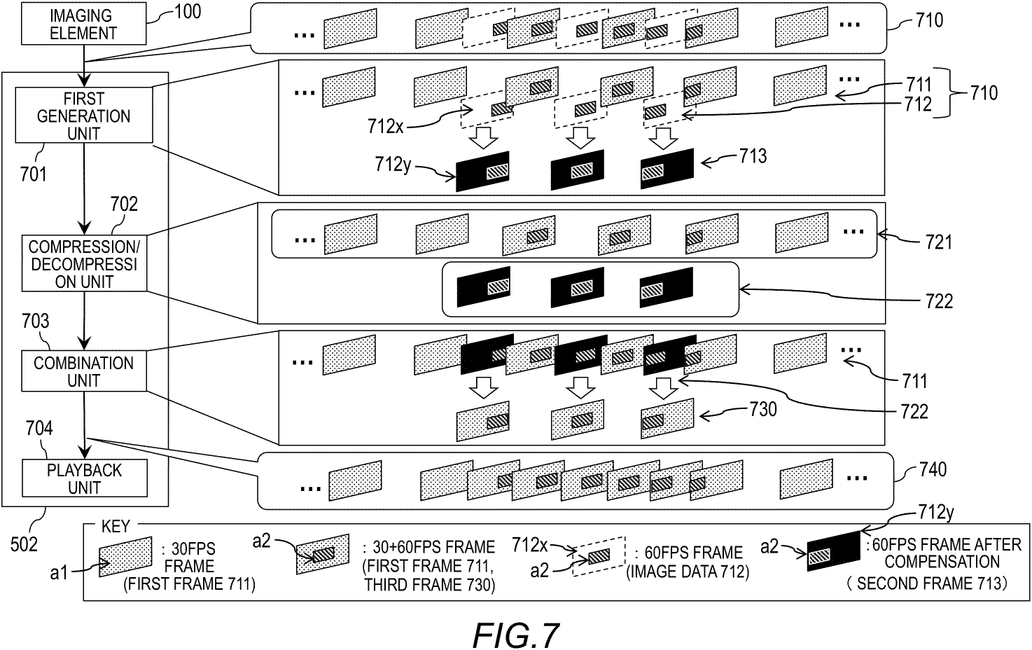

FIG. 7 illustrates a video compression and decompression example according to the illustrative embodiment 1. The electronic apparatus 500 has the above-described imaging element 100 and the control unit 502. The control unit 502 includes a first generation unit 701, a compression/ decompression unit 702, a combination unit 703, and a playback unit704. The imaging element 100 has a plurality of imaging regions to image a subject as described above. An imaging region is a collection of at least one or more pixels and is the above-described one or more blocks 202. An imaging region can have a frame rate set for each block 202.

Here, in the imaging surface 200, an imaging region set at a first frame rate (30 fps, for example) is referred to as a “first imaging region,” and an imaging region set at a second frame rate that is faster than the first frame rate (60 fps, for example) is referred to as a “second imaging region.” These values for the first frame rate and the second frame rate are merely one example, and other values may be set as long as the second frame rate is faster than the first frame rate. If the second frame rate is a multiple of the first frame rate, then it is possible to attain a frame outputted from the first imaging region and the second imaging region at the imaging timing of the first frame rate.

The imaging element 100 captures a subject and outputs input video data 710 to the first generation unit 701. The region of the image data outputted from the imaging region where the imaging element 100 is present is referred to as an image region (corresponding to the imaging region).

If the entire imaging surface 200 is the first imaging region set at the first frame rate (30 fps), for example, then the image data of a first image region a1 (shaded) outputted from the first imaging region (entire imaging surface 200) by imaging at the first frame rate (30 fps) becomes one frame as a result of image processing. This frame is referred to as a “first frame 711.”

Specifically, if performing fixed point imaging of a landscape, for example, then the first frame 711 is generated as the image data of the first image region a1 of only the landscape by imaging at the first frame rate (30 fps).

Also, if the entire imaging surface 200 is the first imaging region set at the first frame rate (30 fps) and an imaging region where a specific subject was detected is switched from the first imaging region to the second imaging region set to the second frame rate (60 fps), for example, then the combination of the image data of the first image region a1 (shaded) outputted from the first imaging region by imaging at the first frame rate (30 fps) and the image data of the second image region a2 outputted from the second imaging region also constitutes the first frame 711.

Specifically, if a specific subject (train) is detected while performing fixed point imaging of a landscape, for example, then the first frame 711 is generated as a combination of the image data of the landscape (first image region a1) excluding the train attained at the first frame rate (30 fps) and the image data of the train (second image region a2) attained at the second frame rate (60 fps).

Also, in this case, the image data of the second image region a2 outputted from the second imaging region that is outputted from the second imaging region of the imaging surface 200 by imaging performed at the second frame rate (60 fps) is referred to as “image data 712.” In this case, the image region from which the image data of the subject was outputted from the first imaging region is referred to as a “loss region 712x.”

Specifically, if a specific subject (train) is detected while performing fixed point imaging of a landscape, for example, then the image data of the train (second image region a2) attained by imaging at the second frame rate (60 fps) is the image data 712.

There may be three or more imaging regions set at differing frame rates. In this case, for third and subsequent imaging regions, a frame rate differing from the first and second frame rates can be set.

The first generation unit 701 compensates the image data 712 among the input video data 710 inputted from the imaging element 100. Specifically, the first generation unit 701 compensates with a specific color the loss region 712x where no image signal was outputted from the first imaging region of the imaging element 100. In this example, the specific color is black, and black is also used in FIG. 7. The specific color may be a color other than black or may be a specific pattern. Also, the specific color may be not just one color but a plurality of colors. Additionally, the pixel area surrounding the second image region a2 may be the same color as the boundary of the second image region a2. The loss region 712x compensated by the specific color is referred to as a “compensated region 712y.”

The image data formed by combining the image data 712 with the compensated region 712y by image processing is referred to as a second frame 713. Video data constituted of a group of first frames 711 is referred to as first video data 721, and video data constituted of a group of second frames 713 is referred to as second video data 722. The first generation unit 701 outputs the first video data 721 and the second video data 722 to the compression/decompression unit 702.

The compression/decompression unit 702 compresses the first video data 721 and the second video data 722 and stores the data in a storage device (such as a memory card 504 or a flash memory 507). The compression unit 702 executes the compression by a hybrid coding obtained by combining, for example, a motion compensation inter-frame prediction (Motion Compensation: MC) and a discrete cosine conversion (Discrete Cosine Transform: DCT) with the entropy coding.

The compression/decompression unit 702 subjects the first image region a1 shown by the halftone dot meshing of the first frame 711 constituting the first video data 721 to a compression processing not requiring the motion detection or the motion compensation. The compression/decompression unit 702 compresses the image data 712 of the second image region a2 from which the hatched specific subject image is output by the above-described hybrid coding. In this manner, the first image region a1 other than the specific subject image is not subjected to the motion detection or the motion compensation, thus achieving the reduced processing load of the video compression.

Assuming that there is no camera shake of the imaging apparatus or that the subject does not move, the compression/decompression unit 702 executes a compression process that does not require motion detection or motion compensation for the first image region a1. However, when there is camera shake or movement of the subject, the compression/decompression unit 702 may compress the first image region a1 by the hybrid coding described above.

Similarly, the compression/decompression unit 702 subjects the compensated region 712y filled with black of the second frame 712 constituting the second video data 722 to a compression processing not requiring the motion detection or the motion compensation. The compression/decompression unit 702 compresses the image data 712 of the second image region a2 from which the hatched specific subject image is output by the above-described hybrid coding. In this manner, the compensated region 712y (filled with black) other than the specific subject image is not subjected to the motion detection or the motion compensation, thus achieving the reduced processing load of the video compression. Also, if there is camera shake or the subject moves, the compression/decompression unit 702 may perform compression through the above-mentioned hybrid encoding for the compensated region 712y.

In this manner, the second frame 713 attained at the second frame rate (60 fps) is the same size as the first frame 711 attained at the first frame rate (30 fps). Thus, the second frame 713 is subjected to the same compression process as the first frame 711, and therefore, another compression process compatible with the size of the image data 712 need not be used.

Also, if the compression/decompression unit 702 has a playback instruction or a decompression instruction for a video, then the compressed first video data 721 and second video data 722 are decompressed, thus restoring the original first video data 721 and second video data 722.

The combination unit 703 refers to the first frame 711 that immediately precedes the second frame 713 temporally to copy the first frame 711 to the second frame 713, or in other words, to combine the frames. Specifically, the combination unit 703 generates another first frame 711 to combine with the second frame by copying the first frame 711, and combines the generated first frame with the second frame. The combined frame is referred to as a “third frame 730.” The third frame 730 is a frame in which a specific subject image (second image region a2) in the second frame 713 is superimposed on the subject image of the first frame 711. The combination unit 703 outputs, to the playback unit 704, video data 740 (hereinafter referred to as fourth video data) including the first frames 711 outputted through imaging at 30 fps and the third frames 730 that are the combined frames. If there is no combination instruction, then if playing back the video at 30 fps, for example, the combination unit 703 does not execute the combination process.

The playback unit 704 plays back the fourth video data 740 and displays the video in the liquid crystal monitor 503. Thus, the above-mentioned input video data 710 cannot be compressed as is by the compression/decompression unit 702. Therefore, the first generation unit 701 compensates the image data 712 with the compensated region 712y to generate the second video data 722 constituted of a plurality of the second frames 713. The compression/decompression unit 702 separately compresses and decompresses the first video data 721 and the second video data 722.

Thus, it is possible to compress the second video data 722 in a similar manner to normal video data (first video data 721) using a general purpose compression/decompression unit 702. If the combination unit 703 has not executed the combination process, the playback unit 704 plays back the first video data 721 with a frame rate of 30 fps and displays the video in the liquid crystal monitor 503.

In the above example, a case was described in which the entire imaging surface 200 is the first imaging region set at the first frame rate (30 fps) and an imaging region where a specific subject was detected is switched from the first imaging region to the second imaging region set to the second frame rate (60 fps), but the setting of imaging conditions for the imaging regions of the imaging surface 200 is not limited thereto.

If, for example, in the imaging surface 200, a plurality of the first imaging regions set at the first frame rate (30 fps) and a plurality of the second imaging regions set at the second frame rate (60 fps) coexist in a staggered pattern, then the image data formed by combining the plurality of first image regions a1 corresponding to the plurality of first imaging regions constitutes the first frames F711. Also, in this case, the image data formed by combining the plurality of second image regions a2 corresponding to the plurality of second imaging regions constitutes the “second frames F712.” In a staggered arrangement, a configuration may be adopted in which the frame rates of the first imaging region and the second imaging region are set to be the same, but other imaging conditions such as the exposure time, the ISO speed, and the thinning rate are set to differ between the first imaging region and the second imaging region.

### File Format Example for Video Files

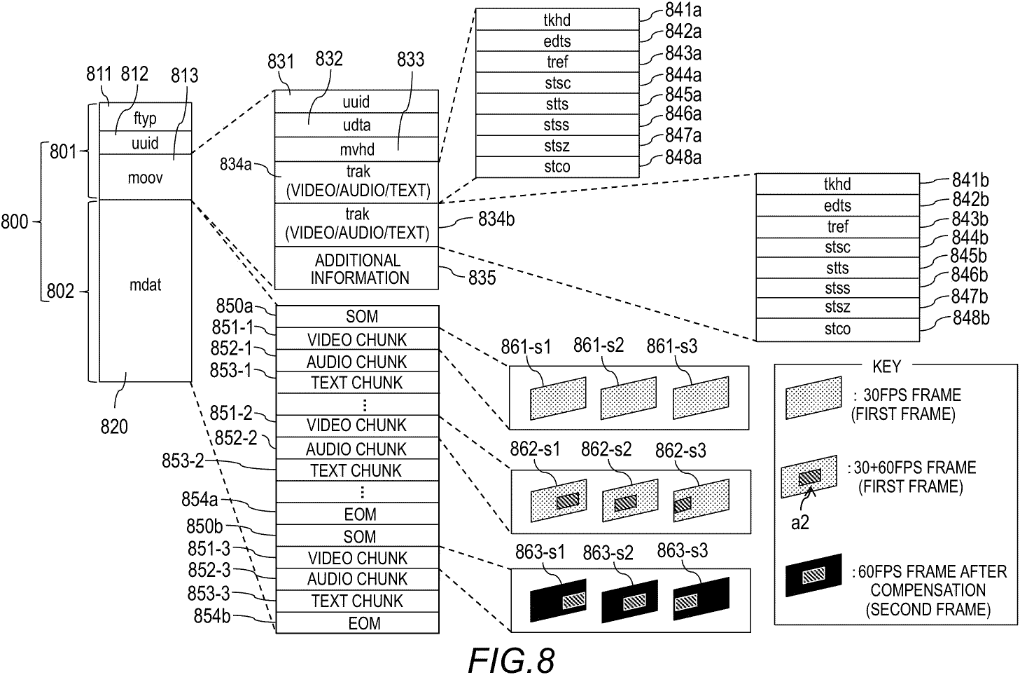

FIG. 8 is a descriptive view showing a file format example for video files. In FIG. 8, an example is shown in which a file format that conforms to MPEG-4 (Moving Picture Experts Group-phase 4) is used.

A video file 800 is a collection of data referred to as boxes, and has a header portion 801 and a data portion 802, for example. The header portion 801 includes, as boxes, an ftyp 811, a uuid 812, and a moov 813. The data portion 802 includes, as a box, an mdat 820.

The ftyp 811 is a box that stores information indicating the type of video file 800, and is disposed at a position in front of other boxes in the video file 800. The uuid 812 is a box that stores a general purpose unique identifier, and is expandable by the user. In Embodiment 1, the uuid 812 may have written thereto frame rate identification information identifying whether the video data is one in which the frame rate of the frame group in the video file 800 is only at the first frame rate (30 fps, for example), or the video data (first video data 721 and second video data 722) includes both the first frame rate and the second frame rate (60 fps). As a result, during decompression, combination, or playback, it is possible to identify which video data is at which frame rate.

The moov 813 is a box that stores metadata pertaining to various types of media such as video, audio, or text. The mdat 820 is a box that stores of data of the various types of media such as video, audio, or text.

Next, the boxes in the moov 813 will be explained in detail. The moov 813 has a uuid 831, a udta 832, an mvhd 833, a trak 834a and 834b, and additional information 835. If not distinguishing between the trak 834a and 834b, these are referred to simply as the trak 834. Similarly, if not distinguishing between a tkhd 841a or the like in the trak 834a and a tkhd 841b or the like in the trak 834b, these are referred to simply as the tkhd 841.

The uuid 831, similar to the uuid 812, is a box that stores a general purpose unique identifier, and is expandable by the user. In Embodiment 1, for example, when generating the video file 800, the uuid 831 has written thereto, in association with the frame numbers, frame type identification information that identifies whether the frames in the video file 800 are the first frames 711 or the second frames 713.

Also, the uuid 831 may have written thereto information indicating the storage location of compressed data of the first video data 721 and compressed data of the second video data 722. Specifically, for example, SOM (start of movie) 850a or EOM (end of movie) 854a is written as information indicating the storage location of the compressed data of the first video data 721, and SOM 850b or EOM 854b is written as information indicating the storage location of the compressed data of the second video data 722. As a result, during decompression, combination, or playback, it is possible to identify which video data is stored at which storage location.

The storage location of the compressed data can be identified by an stsz 847a and 847b and an stco 848a and 848b to be mentioned later. Thus, the address of the compressed data of the first video data 721 identified by the stsz 847a and 847b and the stco 848a and 848b instead of the SOM 850a and the EOM 854a may be associated with the first frame rate information indicating the first frame rate, with the stsz 847a and 847b and the stco 848a and 848b being set as the information indicating the storage location.

Similarly, the address of the compressed data of the second video data 722 identified by the stsz 847a and 847b and the stco 848a and 848b instead of the SOM 850b and the EOM 850b may be associated with the second frame rate information indicating the second frame rate, with the stsz 847a and 847b and the stco 848a and 848b being set as the information indicating the storage location.

The udta 832 is a box in which user data is stored. Examples of user data include the identification code of the electronic apparatus or the location information of the electronic apparatus.

The mvhd 833 is a box that stores a time scale and a duration for each trak 834. The time scale is the frame rate or a sampling frequency. The duration is the length based on the time scale. If the duration is divided by the time scale, then the time length of the media identified by the trak 834 is attained.

The trak 834 is a box that is set for each type of media (video, audio, text). In the present embodiment, moov includes the trak 834a and 834b. The trak 834a is a box that stores metadata pertaining to a video, audio, and text of the first video data 721 outputted by 30 fps imaging, for example.

The trak 834a is set for each video, audio, and text of the first video data 721. The trak 834b is a box that stores metadata pertaining to a video, audio, and text of the second video data 722 outputted by 60 fps imaging, for example. The trak 834b is set for each video, audio, and text of the second video data 722.

The additional information 835 is a box including imaging condition information and insertion position information. The imaging condition information is information indicating the storage location of media in the video file 800 for each imaging condition (a frame rate of 30 fps or 60 fps, for example). The insertion position information is information indicating the position at which the data of the media with the faster frame rate (second video data 722) is inserted into the data of the media with the slower frame rate (first video data 721).

Next, the boxes in the trak 834 will be explained in detail. The trak 834a and 834b each have a tkhd 841a and 841b, an edts 842a and 842b, a tref 843a and 843b, an stsc 844a and 844b, an stts 845a and 845b, an stss 846a and 846b, an stsz 847a and 847b, and an stco 848a and 848b. If not distinguishing between the tkhd 841a to stco 848a and the tkhd 841b to stco 848b, these are simply referred to as the tkhd 841 to stco 848.

The tkhd 841 is a box that stores basic attributes of the trak 834 such as the playback time and display resolution of the trak 834 and an identification code determining the type of media. For example, if the trak 834 is a video, then the media ID is 1, if the trak 834 is audio, then the media ID is 2, and if the trak 834 is text, then the media ID is 3.

The edts 842 is a box that stores the playback start position and the playback time from the playback position of the trak 834 as an edit list of the trak 834. The tref 843 is a box that stores reference information among the trak 834. If a video trak 834 refers to a text trak 834 as a chapter, then the tref 843 of the video trak 834 stores a media ID of 3 indicating a text trak 834 and refers to the text trak 834 as a chapter, and thus, has stored therein an identification code of “chap.”

The stsc 844 is a box that stores a sample count in each chunk. A chunk is a collection of data of media for a given sample count, and is stored in the mdat 820. If the media is a video, for example, then the sample in the chunk is a frame. If the sample count is “3,” this signifies that three frames are stored in each chunk.

The stts 845 is a box that stores a playback time for each chunk or samples in each chunk in the trak 834. The stss 846 is a box that stores information pertaining to the interval of key frames (I-pictures). If the GOP (group of pictures) is “5,” the stss 846 stores “1, 6, 11, ...”

The stsz 847 is a box that stores the data size of each chunk in the mdat 820. The stco 848 is a box that stores the offset from an initial address of the video file 800 for each chunk in the mdat 820. By referring to the stsz 847 and the stco 848, it is possible to identify the location of data (frame, audio data, text (chapter)) of the media in the mdat 820.

The mdat 820 is a box that stores chunks for each media. SOMs 850a and 850b (referred to as SOM 850 if no distinction is made) are identifiers for indicating the starting position for storing a group of chunks for a given imaging condition. Also, EOMs 854a and 854b (referred to as EOM 854 if no distinction is made) are identifiers for indicating the ending position for storing a group of chunks for a given imaging condition.

In FIG. 8, the mdat 820 stores a video chunk 851-1, an audio chunk 852-1, a text chunk 853-1... a video chunk 851-2, an audio chunk 852-2, a text chunk 853-2... a video chunk 851-3, an audio chunk 852-3, and a text chunk 853-3.

This example is one in which video imaging occurs under two imaging conditions (30 fps, 60 fps), and thus, the chunks are subdivided according to the imaging condition. Specifically, for example, a group of chunks attained at an imaging timing of 30 fps is stored for the SOM 850a to the EOM 854a, and a group of chunks attained at an imaging timing of 60 fps is stored for the SOM 850b to the EOM 854b.

The video chunk 851-1 stores compressed frames of the first frame 711 prior to detection of a specific subject that is a sample outputted through imaging at 30 fps, or in other words, compressed frames 861-s1, 861-s2, and 861-s3. The video chunk 851-2 stores compressed frames of the first frame 711 upon detection of a specific subject that is a sample outputted through imaging at 30 fps, or in other words, compressed frames 862-s1, 862-s2, and 862-s3. The frames 862-s1, 862-s2, and 862-s3 overlap the 60 fps imaging timing, and thus, includes the specific subject image (second image region a2) at 60 fps.

The video chunk 851-3 stores compressed frames of the second frame 713 upon detection of a specific subject that is a sample outputted through imaging at 60 fps, or in other words, compressed frames 863-s1, 863-s2, and 863-s3.

### Additional Information

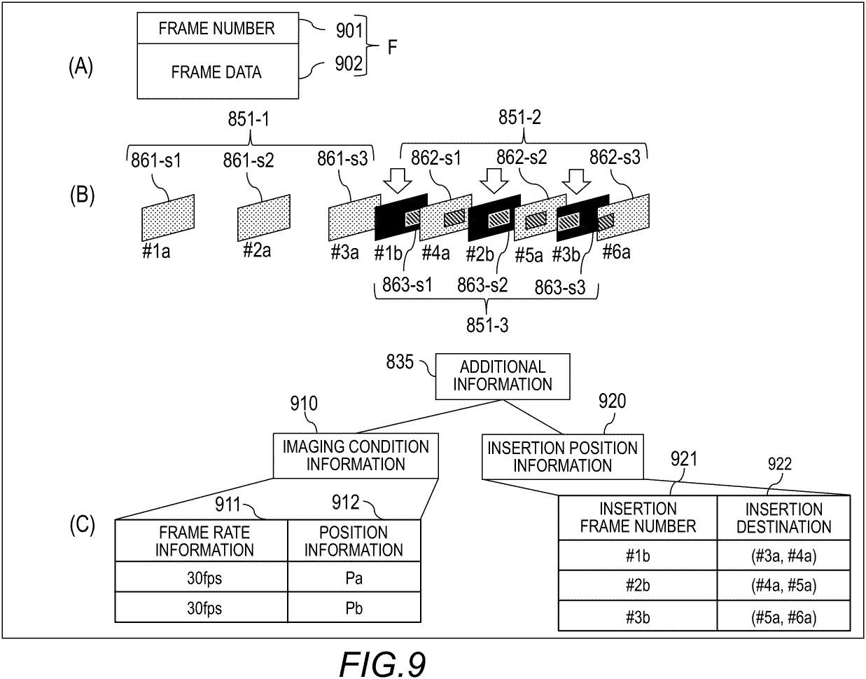

FIG. 9 is a descriptive drawing showing the relationship between the frames and the additional information 835. (A) shows a data structure example for a frame F. The frame F has a frame number 901 and frame data 902. The frame data 902 is image data generated by imaging.

(B) shows a compressed frame example. In (B), the compressed frames are arranged in chronological order from left (oldest) to right (newest). #1a to #6a are frame numbers for compressed frames 861-s1, 861-s2, 861-s3, 862-s1, 862-s2, and 862-s3 outputted by imaging at 30 fps. #1b to #3b are frame numbers for compressed frames 863-s1, 863-s2, and 863-s3 outputted by imaging at 60 fps.

(C) shows a data structure example of the additional information 835. The additional information 835 has imaging condition information 910 and insertion position information 920. As described above, the imaging condition information 910 is information indicating the storage location of media in the video file 800 for each imaging condition (a frame rate of 30 fps or 60 fps, for example). The imaging condition information 910 has frame rate information 911 and position information 912.

The frame rate information 911 is a frame rate of 30 fps or 60 fps, for example. The position information 912 is information indicating the storage position of the compressed frame in the video file 800, and can be identified by referring to the stsz 847 and the stco 848. Specifically, for example, a value Pa of the position information 912 of the compressed frame where the frame rate information 911 indicates 30 fps indicates an address in the range of the SOM 850a to the EOM 854a. Similarly, a value Pb of the position information 912 of the compressed frame where the frame rate information 911 indicates 60 fps indicates an address in the range of the SOM 850b to the EOM 854b.

The insertion position information 920 is information indicating the position at which the data of the media (second video data 722) with the faster frame rate (60 fps) is inserted into the data of the media (first video data 721) with the slower frame rate (30 fps). The insertion position information 920 has an insertion frame number 921 and an insertion destination 922. The insertion frame number 921 indicates the frame number of the compressed frame to be inserted. In this example, the compressed frames to be inserted are the compressed frames 863-s1, 863-s2, and 863-s3 identified by the frame numbers #1b to #3b.

The insertion destination 922 indicates the insertion position of the compressed frame identified by the insertion frame number 921. The insertion destination 922 is specifically identified as being between two frame numbers, for example. For example, the compressed frame 863-s1 with the insertion frame number #1b is inserted between the compressed frames 861-s3 and 862-s1 identified by the two frame numbers (#3a, #4a) of the insertion destination 922. In FIG. 9, the insertion destination 922 is identified by the frame number, but may instead be identified by the address (identified by referring to the stsz 847 and the stco 848).

In FIGS. 8 and 9, an example was described in which compressed data in which the first frames 711 are compressed and compressed data in which the second frames 713 are compressed are stored in one video file 800, but a video file in which the first frames 711 are compressed and a video file in which the second frames 713 are compressed may be separately generated. In this case, association information in which one video file 800 is associated with another video file 800 would be stored in the header portion 801 of both video files 800. The association information is stored in the uuid 812 and 831 and the mvhd 833 of the header portion 801, for example.

As a result, it is possible to perform decompression, combination, and playback in a manner similar to a case in which one video file 800 is used. If the first frame rate is selected, for example, a video file in which the first frames 711 are compressed is decompressed and played back, and if the second frame rate is selected, the video file 800 in which the first frames 711 are compressed and the video file 800 in which the second frames 713 are compressed are decompressed, combined, and played back.

If the additional information 835 is stored in the moov 813, then the additional information may additionally be stored other boxes (831-834).

### Combination Process Example

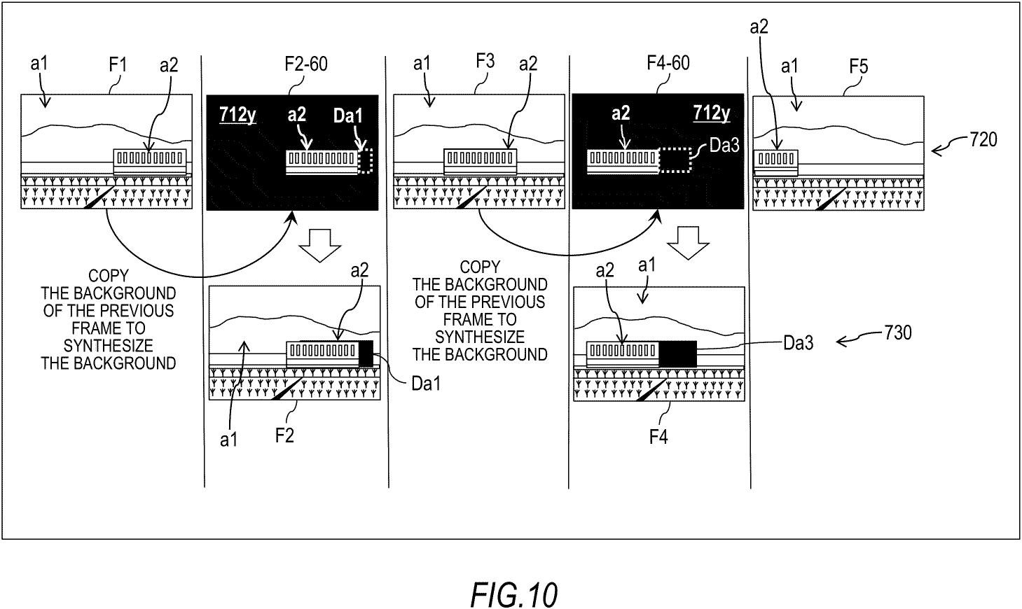

FIG. 10 is a descriptive drawing showing combination process example 1 in the combination unit 703 shown in FIG. 7. In the combination process example 1, the electronic apparatus 500 photographs a running railway train as a specific subject during a fixed point photographing operation of a scenery including a rice field, mountain, and sky. The railway train as a specific subject is identified by the above-described well-known subject detection technique. The photographed frames are frames F1, F2-60, F3, F4-60, and F5 in the order of time scales. It is assumed that the railway train runs within the frames F1, F2-60, F3, F4-60, and F5 from the right side to the left side.

The frames F1, F3, and F5 are the first frame 711 that includes the image data of the first image region a1 output by imaging the first imaging region at the first frame rate of 30[fps] and the image data of the second image region a2 output by imaging the second imaging region at the second frame rate of 60[fps]. The frames F2-60 and F4-60 are the second frame 713 including the image data of the second image region a2 output by imaging the second imaging region at the second frame rate of 60[fps] and with the background complemented by black paint.

Specifically, the frames F1, F3, and F5 for example are the first frame 711 in which the first image region a1 includes an image of the scenery including the rice field, mountain, and sky and the second image region a2 includes an image of the running railway train as a specific subject. The frames F2-60 and F4-60 are a frame in which the second image region a2 includes the image of the railway train.

Specifically, the frames F1, F2-60, F3, F4-60, and F5 have the image data of the second image region a2 including the image of the railway train that is image data imaged in the second imaging region (60[fps]). The frames F1, F3, and F5 have the image data of the first image region a1 including the image of the scenery that is image data imaged in the first imaging region (30[fps]). The first image region a1 is outputted upon being imaged at the first frame rate (30 fps), and thus, the compensated region 712y of the frames F2-60 and F4-60 outputted upon being imaged at the second frame rate (60 fps) are filled with a specific color (black).

The frames F1, F2-60, F3, and F4-60... correspond the above-described first video data 721 and second video data 722. The second video data 722 includes the second frames 713 in which the compensated region 712y is filled, and thus, the combination unit 703 combines the first video data 721 and the second video data 722.

Specifically, the combination unit 703 for example copies the image data of the second image region a2 of the frames F2-60 (railway train) on the image data of the first image region a1 of the frame F1 temporally previous to the frames F2-60 (the scenery excluding the railway train). This allows the combination unit 703 to generate the frame F2 that is the third frame 730.

This operation is similarly performed on the frames F4-60. The combination unit 703 copies the image data of the second image region a2 of the frames F4-60 (railway train) to the image data of the first image region a1 of the previous frame F3 (the scenery excluding the railway train) temporally previous to the frames F4-60. This allows the combination unit 703 to generate the frame F4 as the third frame 730. Then, the combination unit 703 outputs the the fourth video data 740 including the frames F1-F5.

In this manner, by setting the immediately previous first image region a1 of the frames F1 and F3 at the first frame rate in the compensated region 712y of the frames F2-60 and F4-60, it is possible to set the difference between the frames F1 and F2 to substantially 0 and the difference between the frames F3 and F4 to substantially 0 in the first image region a1. As a result, it is possible to play back a video with a natural appearance.

Thus, it is possible to play back the fourth video data 740, which is a frame array in which the first frames 711 and the third frames 730 are both present. Also, the first video data 721 and the second video data 722 can both be decompressed by a conventional compression/decompression unit 702, and it is possible to reduce the processing load of the decompression process. If playing back at 30 fps, the compression/decompression unit 702 only decompresses the first video data 721 and combination by the combination unit 703 is unnecessary, and thus, it is possible to increase the efficiency of the playback process.

It is noted that the image data of the first image region a1 of the frame F1 (the scenery excluding the railway train) is copied to the frame F2. Thus, a part of the frame F1 that was originally the second image region a2 (an end of the railway train) is not copied to the frame F2. Thus, the frame F2 has the compensated image section Dal to which nothing is outputted.

Similarly, the image data of the first image region a1 of the frame F3 (the scenery excluding the railway train) is copied to the frame F4. Thus, a part of the frame F3 that was originally the second image region a2 (the end of the railway train) is not copied to the frame F4. Thus, the frame F4 has the compensated image section Da3 to which nothing is outputted.

In the illustrative embodiment 1, the compensated image sections Da1 and Da3 may be painted by the combination unit 703 with a specific color or the surrounding pixels may be subjected to a compensation process. This can consequently reproduce the frames F2 and F4,... that can be subjected to the video compression and that can cause a reduced sense of incongruity.

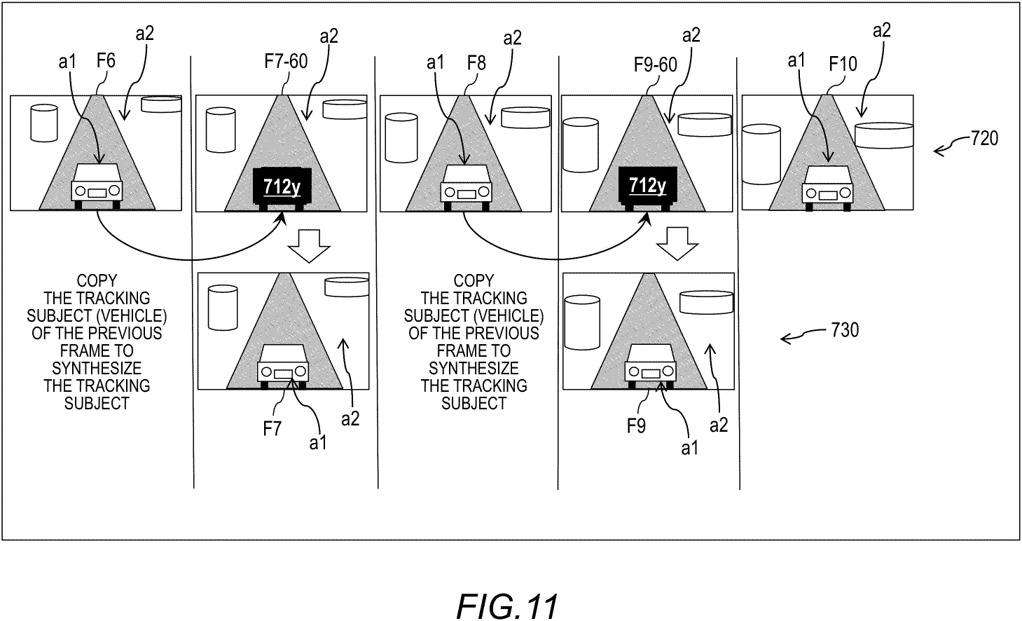

FIG. 11 is a descriptive drawing showing combination process example 2 in the combination unit 703 shown in FIG. 7. In the combination process example 2, the electronic apparatus 500 is a drive recorder for example and photographs a vehicle running at the front side (preceding vehicle) and the scenery. In this case, the preceding vehicle is a specific subject to be tracked and the scenery changes in accordance with the travel of the running vehicle. The photographed frame is the frames F6, F7-60, F8, F9-60, and F10 in the order of time scales.

The frames F6, F8, and F10 are the first frame 711 that includes the image data of the first image region a1 output by imaging the first imaging region at the first frame rate of 30[fps] and the image data 712 of the second image region a2 output by imaging the second imaging region at the second frame rate of 60[fps]. The frames F7-60 and F9-60 are the image data 712 of the second image region a2 output by imaging the second imaging region at the second frame rate of 60[fps]

Specifically, for example the frames F6, F8, and F10 are the first frame 711 in which the preceding vehicle is imaged in the first image region a1 and a changing scenery is imaged in the second image region a2. The frames F7-60 and F9-60 are frames in which the second image region a2 includes an image of the scenery.

Specifically, the frames F6, F7-60, F8, F9-60, and F10 are configured so that the image data of the second image region a2 including the image of the scenery is image data imaged by the second imaging region (60[fps]). The frames F6, F8, and F10 are configured so that the image data of the first image region a1 including the image of the preceding vehicle is image data imaged by the first imaging region (30[fps]). The first image region is outputted upon being imaged at the first frame rate (30 fps), and thus, the first imaging region a1 of the frames F7-60 and F9-60 outputted upon being imaged at the second frame rate (60 fps) are filled with black by the first generation unit 701 during compression.

The combination unit 703 copies the image data of the second image region a2 of the frame F7-60 (scenery) to the image data of the first image region a1 (the preceding vehicle excluding the scenery) of the frame F6 temporally previous to the frame F7-60. This consequently allows the combination unit 703 to generate the frame F7 as the third frame 730.

Similarly, the frame F9 is handled so that the combination unit 703 copies the image data of the second image region a2 of the frame F9-60 (scenery) to the image data of the first image region a1 of the frame F8 temporally previous to the frame F9-60 (the preceding vehicle excluding the scenery). This consequently allows the combination unit 703 to generate the frame F9 as the third frame 730. Then, the combination unit 703 outputs the fourth video data 740 including the frames F6-F10.

In this manner, by setting the immediately previous second image region a2 of the frames F6 and F8 at the first frame rate in the compensated region 712y of the frames F7-60 and F9-60, it is possible to set the difference between the frames F6 and F7 to 0 and the difference between the frames F8 and F9 to 0 in the first image region a1.

Thus, it is possible to play back the fourth video data 740, which is a frame array in which the first frames 711 and image data 712 are both present. Also, the first video data 721 and the second video data 722 can both be decompressed by a conventional compression/decompression unit 702, and it is possible to reduce the processing load of the decompression process. If playing back at 30 fps, the compression/decompression unit 702 only decompresses the first video data 721 and combination by the combination unit 703 is unnecessary, and thus, it is possible to increase the efficiency of the playback process.

### Configuration Example of Control Unit 502

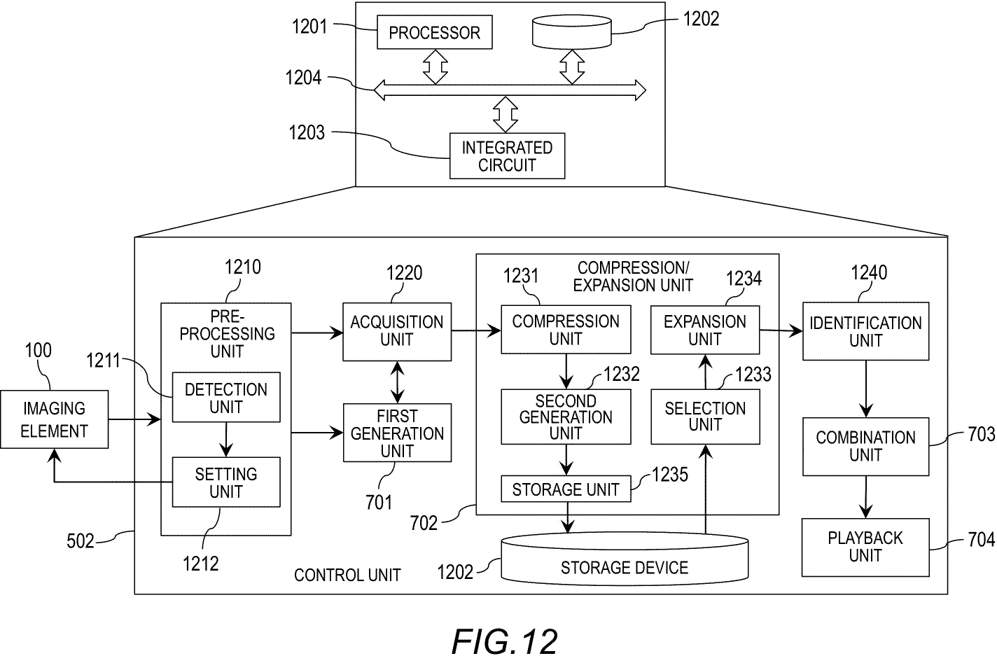

FIG. 12 is a block diagram showing a configuration example of the control unit 502 shown in FIG. 5. The control unit 502 has a pre-processing unit 1210, the first generation unit 701, an acquisition unit 1220, the compression/decompression unit 702, an identification unit 1240, the combination unit 703, and the playback unit 704. The control unit 502 is constituted of a processor 1201, a storage device 1202, an integrated circuit 1203, and a bus 1204 that connects the foregoing components. The storage device 1202, a decompression unit 1234, the identification unit 1240, the combination unit 703, and the playback unit 704 may be installed in another apparatus that can access an electronic apparatus 500.

The preprocessing unit 1210, the first generation unit 701, the acquisition unit 1220, the compression/decompression unit 702, the identification unit 1240, the combination unit 703, and the playback unit 704 may be realized by allowing a program stored in the memory 1202 to be executed by the processor 1201 or may be realized by the integrated circuit 1203 (e.g., ASIC(Application Specific Integrated Circuit) or FPGA(Field-Programmable Gate Array)). The processor 1201 may use the memory 1202 as a work area. The integrated circuit 1203 may use the memory 1202 as a buffer to temporarily retain various pieces of data including image data.

An apparatus that includes at least the compression/decompression unit 702 and a compression unit 1231 is a video compression apparatus. An apparatus that includes at least the compression/decompression unit 702 and a second generation unit 1232 is a generation apparatus. Also, an apparatus that includes at least the compression/decompression unit 702 and a decompression unit 1234 is a decompression apparatus. Additionally, an apparatus that includes at least the playback unit 704 is a playback apparatus.

The preprocessing unit 1210 subjects the input video data 710 from the imaging element 100 to the preprocessing for the generation of the movie file 800. Specifically, the preprocessing unit 1210 has a detection unit 1211 and a setting unit 1212 for example. The detection unit 1211 detects a specific subject by the above-described well-known subject detection technique.

The setting unit 1212 changes the frame rate of an imaging region of the imaging face 200 of the imaging element 100 in which a specific subject is detected from the first frame rate (e.g., 30[fps]) to the second frame rate (60[fps]).

Specifically, the setting unit 1212 detects the motion vector of the specific subject from a difference between the imaging region in which a specific subject is detected in the input frame and an imaging region in which the specific subject of an inputted frame is detected for example to predict the imaging region of the specific subject at the next input frame. The setting unit 1212 changes the frame rate for the predicted imaging region to the second frame rate. The setting unit 1212 adds, to the frame F, information indicating the image region at the first frame rate (30 fps, for example) and the image region at the second frame rate (60 fps, for example).

The first generation unit 701 compensates the loss region 712x that was not outputted upon imaging at the second frame rate with a specific color to form the compensated region 712y for the image data 712 that is the image region at the second frame rate in which the specific subject is captured. Specifically, for example, in the frames F2-60 and F4-60 of FIG. 10, the image region (corresponding to the background) other than the second image region a2 that is the specific subject image outputted upon imaging at 60 fps is the compensated region 712y.

Also, in the frames F7-60 and F9-60 of FIG. 11, the image region (corresponding to the preceding vehicle) other than the second image region a2 that is changing scenery imaged at 60 fps is the compensated region 712y. The first generation unit 701 sets the loss region 712x to the specific color to erase the loss region 712x.

In this manner, the image data of the compensated region 712y of the specific color is data not based on the output from the second imaging region, and is configured as prescribed data that has no relation to the output data from the second imaging region.

The acquisition unit 1220 acquires the input video data 710 outputted from the pre-processing unit 1210 or the first video data 721 and the second video data 722 and stores the acquired data in the storage device 1202, and outputs a plurality of frames at a prescribed timing in chronological order to the compression/decompression unit 702 one frame at a time. Specifically, for example, the acquisition unit 1220 acquires the input video data 710 from the pre-processing unit if the specific subject is not detected, and acquires the first video data 721 and the second video data 722 if the specific subject is detected.

The compression/decompression unit 702 has the compression unit 1231, the second generation unit 1232, the selection unit 1233, the decompression unit 1234, and a storage unit 1235. The compression unit 1231 compresses the video data from the acquisition unit 1220. Specifically, for example, if the compression unit 1231 acquires video data in which the specific subject is not detected, then each frame is in the first image region a1, and thus, a compression process that does not require motion detection or motion compensation is executed.

Also, if the compression unit 1231 acquires the first video data 721 and the second video data 722, then the compression unit compresses both the first video data 721 and the second video data 722. Specifically, for example, if the compression unit 1231 acquires the first video data 721, then a compression process that does not require motion detection or motion compensation is executed for the image data of the first image region a1, and image data of the second image region a2 in which the specific subject is captured is compressed by the above-mentioned hybrid encoding. As described above, regions other than the one including the specific subject image are not subjected to the motion detection or the motion compensation, thus reducing the video compression processing load.

Also, in the case of the second video data 722 as well, the compression unit 1231 executes a compression process that does not require motion detection or motion compensation for the image data of the compensated region 712y (black fill), and image data of the second image region a2 in which the specific subject is captured is compressed by the above-mentioned hybrid encoding. In this manner, motion detection and motion compensation are not executed for the compensated region 712y other than the specific subject image, and thus, the processing load of video compression is reduced. Also, the compensated region 712y is present, and thus, the second frames 713 can be subjected to the typical video compression process, similar to the first frames 711.

In this manner, the second frame 713 attained at the second frame rate (60 fps) is the same size as the first frame 711 attained at the first frame rate (30 fps). Thus, the second frame 713 is subjected to the same compression process as the first frame 711, and therefore, another compression process compatible with the size of the image data 712 need not be used. In other words, the compression unit 1231 can apply the compression process applied to the first frame 711 to the second frame 713 as well. Thus, there is no need to implement another compression process for the image data 712.

The second generation unit 1232 generates the video file 800 including the video data (compressed data) that was compressed by the compression unit 1231. Specifically, for example, the second generation unit 1232 generates the video file 800 according to the file format shown in FIG. 8. The storage unit 1235 stores the generated video file 800 in the storage device 1202.

A configuration may be adopted in which the compression unit 1231 stores the compressed data in a buffer memory and the second generation unit 1232 reads the compressed data stored in the buffer memory to generate the video file 800, for example.

The selection unit 1233 receives a playback instruction for the video file 800 from the operation unit 505, reads the video file 800 to be decompressed from the storage device 1202, and hands over the video file to the decompression unit 1234. The decompression unit 1234 decompresses the video file 800 handed over from the selection unit 1233 according to the file format.

That is, the decompression unit 1234 executes a general use decompression process. Specifically, for example, the decompression unit 1234 executes a variable length decoding process, inverse quantization, and inverse conversion, uses in-frame prediction or inter-frame prediction, and decompresses the compressed frame to the original frame.

The video file 800 includes the video file 800 in which the video data where the specific subject is not detected is compressed and the video file 800 in which the first video data 721 and the second video data 722 are compressed. In this example, the former video file 800 is video data outputted upon imaging at a frame rate of 30 fps, such as imaging performed at a fixed location of only a background in which no trains are passing through. Thus, when the selection unit 1233 receives the selection of the playback instruction for the video file 800, the decompression unit 1234 decompresses the video file 800 according to the file format.

On the other hand, the video file 800 in which the first video data 721 and the second video data 722 are compressed includes the compressed video data of the first video data 721 and the second video data 722. Thus, when selection of a playback instruction for the video file 800 in which the first video data 721 and the second video data 722 is received, the selection unit 1233 identifies the frame rate selected in the playback instruction (30 fps or 60 fps, for example).

If the selected frame rate is 30 fps, then the selection unit 1233 hands over, to the decompression unit 1234, the chunk group present from the SOM 850a to the EOM 854a in the mdat 820 of the video file 800 as compressed data of the first video data 721. As a result, the decompression unit 1234 can decompress the compressed data of the first video data 721 to the first video data 721.

If the selected frame rate is 60 fps, then the selection unit 1233 hands over, to the decompression unit 1234, the chunk group present from the SOM 850a to the EOM 854a in the mdat 820 of the video file 800 as compressed data of the first video data 721, as well as handing over, to the decompression unit 1234, the chunk group present from the SOM 850b to the EOM 854b in the mdat 820 of the video file 800 as compressed data of the second video data 722. As a result, the decompression unit 1234 can decompress the compressed data of the first video data 721 to the first video data 721 and decompress the compressed data of the second video data 722 to the second video data 722.

In this manner, if there are two pieces of compressed data to be decompressed, then the decompression unit 1234 may perform decompression in the order of the compressed data of the first video data 721 and the compressed data of the second video data 722 (alternatively, the opposite order may be used), or the compressed data of the first video data 721 and the compressed data of the second video data 722 may be decompressed concurrently.

If the first video data 721 and the second video data 722 are decompressed by the decompression unit 1234, then the identification unit 1240 identifies the difference region on the basis of the first frame 711 in the first video data 721 (frame F1 of FIG. 10, for example) and the second frame 713 in the second video data 722 (frame F2-60 of FIG. 10, for example).

The difference region is a region indicating the difference between the second image region a2 corresponding to the second imaging region in the first frame 711 and the second image region a2 corresponding to the second imaging region in the second frame 713. The difference region between the frame F1 and the frame F2-60 is a region Dal having a white-dotted rectangular shape to the rear of the train in the frame F2-60. The difference region between the frame F3 and the frame F4-60 is a region Da3 having a white-dotted rectangular shape to the rear of the train in the frame F4-60.

As shown in FIGS. 7 to 11, the combination unit 703 copies the first frame 711 (frame F1 in FIG. 10, for example) including the image data of the immediately previous first image region a1 onto the second frame 713 (frame F2-60 of FIG. 10, for example), to generate the third frame 730 (frame F2 of FIG. 10, for example). The combination unit 703 may copy image data (rear portion of train) of the second image region a2 in the same position as the difference region in the first frame 711 onto the difference regions (Dal, Da3) identified by the identification unit 1240. As a result, it is possible to set the difference between the temporally consecutive first frame 711 and third frame 730 to substantially 0. Thus, it is possible to play back a video with a natural appearance.

In the identification unit 1240 and the combination unit 703, the insertion position of the frame F2-60 into the first video data 721 is identified by the insertion position information 920 of the additional information 835. Where the frame numbers of the frames F1 and F3 are respectively #4a and #5a and the frame number of the frame F2-60 is #2b, the insertion position 922 of the value #2b of the insertion frame number 921 is (#4a, #5a). Thus, the insertion position of the frame F2-60 is identified as between the frames F1 and F3.

### Configuration Example of the Compression Unit 1231

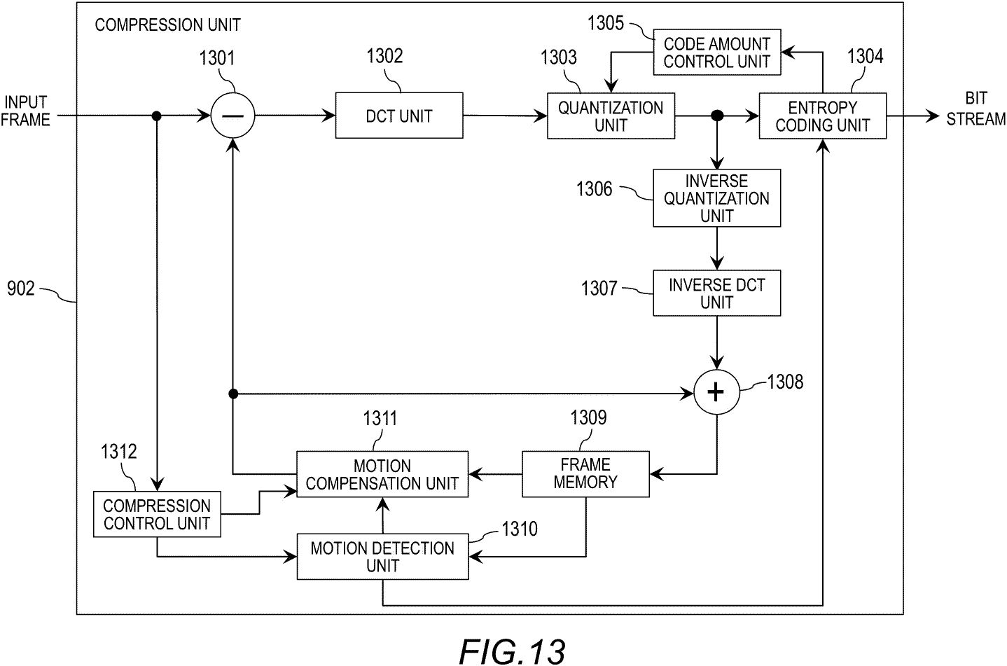

FIG. 13 is a block diagram illustrating the configuration of the compression unit 1231. As described above, the compression unit 1231 compresses the respective frames F from the acquisition unit 1220 by the hybrid coding obtained by combining the motion compensation inter-frame predicted (MC) and the discrete cosine conversion (DCT) with the entropy coding.

The compression unit 1231 includes a subtraction unit 1301, a DCT unit 1302, a quantization unit 1303, an entropy coding unit 1304, a code amount control unit 1305, an inverse quantization unit 1306, an inverse DCT unit 1307, a generation unit 1308, a frame memory 1309, a motion detection unit 1310, a motion compensation unit 1311, and a compression control unit 1312. The subtraction unit 1301 to the motion compensation unit 1311 have a configuration similar to that of the conventional compression unit.

Specifically, the subtraction unit 1301 subtracts, from an input frame, a prediction frame from the motion compensation unit 1311 that predicts the input frame to output difference data. The DCT unit 1302 subjects the difference data from the subtraction unit 1301 to the discrete cosine conversion.

The quantization unit 1303 quantizes the difference data subjected to the discrete cosine conversion. The entropy coding unit 1304 executes the entropy coding on the quantized difference data and also executes the entropy coding on the motion vector from the motion detection unit 1310.

The code amount control unit 1305 controls the quantization by the quantization unit 1303. The inverse quantization unit 1306 executes the inverse quantization on the difference data quantized by the quantization unit 1303 to obtain the difference data subjected to the discrete cosine conversion. The inverse DCT unit 1307 executes an inverse discrete cosine conversion on the difference data subjected to the inverse quantization.

The generation unit 1308 adds the difference data subjected to the inverse discrete cosine conversion to the prediction frame from the motion compensation unit 1311 to generate a reference frame that is referred to by a frame inputted temporally later than the input frame. The frame memory 1309 retains the reference frame obtained from the generation unit 1308. The motion detection unit 1310 uses the input frame and the reference frame to detect a motion vector. The motion compensation unit 1311 uses the reference frame and the motion vector to generate the prediction frame.

Specifically, the motion compensation unit 1311 uses a specific reference frame among a plurality of reference frames retrained by the frame memory 1309 and a motion vector for example to execute the motion compensation on the frame imaged at the second frame rate. The use of the reference frame as a specific reference frame can suppress the high-load motion compensation that requires reference frames other than the specific reference frame. Furthermore, the specific reference frame set as one reference frame obtained from the temporally-previous frame of the input frame can avoid the high-load motion compensation and can reduce the motion compensation processing load.

The compression control unit 1312 controls the motion detection unit 1310 and the motion compensation unit 1311. Specifically, the compression control unit 1312 executes the first compression control method to set a specific motion vector showing that there is no motion is detected by the motion detection unit 1310 and the second compression control method to skip the motion detection itself for example.

A first compression control method will be described here. In the case of the first video data 721, a compression control unit 1312 controls a motion detection unit 1310 such that for the first image region a1 outputted upon imaging at the first frame rate (30 fps, for example), a specific motion vector indicating no motion is set and outputted to the motion compensation unit 1311 instead of detecting a motion vector. Also, the compression control unit 1312 controls the motion detection unit 1310 such that for the second image region a2 outputted upon imaging at the second frame rate (60 fps, for example), the motion vector is detected and outputted to the motion compensation unit 1311. The specific motion vector has no defined direction and has a motion amount of 0. Thus, for the first image region a1 outputted upon imaging at the first frame rate (30 fps, for example), detection of the motion vector is not performed.

In this case, the compression control unit 1312 controls the motion compensation unit 1311 to subject the image data of the first image region a1 to the motion compensation based on the specific motion vector and the reference frame. The compression control unit 1312 subjects the image data of the second image region a2 to motion compensation based on the motion vector detected by the motion detection unit 1310. In the case of the second video data 722, the first image region a1 outputted upon imaging at the first frame rate (30 fps, for example) need only be replaced by a region filled with a specific color.

A second compression control method will be described here. In the case of the first video data 721, the compression control unit 1312 controls the motion vector 1310 while not executing detection of the motion vector for image data of the compensated region 712y. Also, the compression control unit 1312 controls the motion detection unit 1310 such that for the second image region a2 outputted upon imaging at the second frame rate (60 fps, for example), the motion vector is detected.

In this case, the compression control unit 1312 controls the motion compensation unit 1311 to subject the image data of the first image region a1 to the motion compensation based on the reference frame. Specifically, the nonexistence of the motion vector allows the compression control unit 1312 to control the motion compensation unit 1311 to determines, with regard to the image data of the compensated region 712y, a prediction frame to predict a reference frame for a frame temporally previous to the input frame.

The compression control unit 1312 controls the motion compensation unit 1311 to subject the image data of the second image region a2 to the motion compensation based on the reference frame and the motion vector detected by the motion detection unit 1310. In the case of the second video data 722, the first image region a1 outputted upon imaging at the first frame rate (30 fps, for example) need only be replaced by the compensated region 712y.

According to the first compression control method, the motion vector is a specific motion vector, thus simplifying the motion detection at the first image region a1 and the compensated region 712y. This can consequently reduce the video compression processing load. According to the second compression control method, no motion detection is executed on the first image region a1 and the compensated region 712y, thus requiring a less video compression processing load than in the case of the first compression control method.

### Example of the Operation Processing Procedure of the Control Unit 502

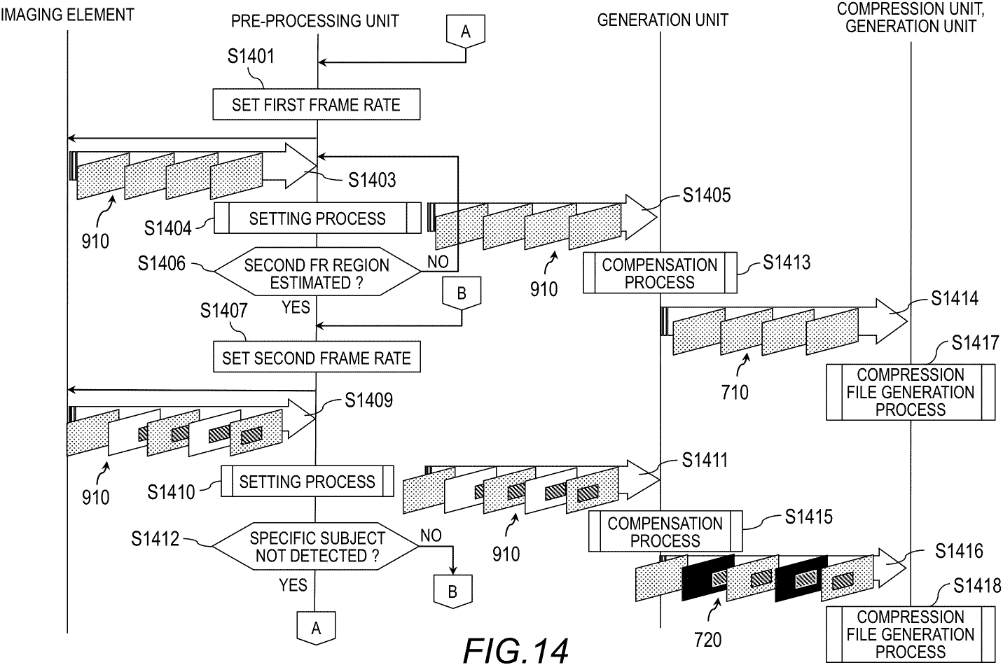

FIG. 14 is a sequence diagram illustrating the operation processing procedure example of the control unit 502. In FIG. 14, the acquisition unit 1220 is omitted for the convenience of illustration. The preprocessing unit 1210 sets the imaging conditions of the entire imaging face 200 of the imaging element 100 to the first frame rate (e.g., 30[fps]) by allowing the user to operate the operation unit 505 for example or by automatically setting the imaging conditions of the entire imaging face 200 of the imaging element 100 to the first frame rate (e.g., 30[fps]) when no specific subject is detected in Step S1412 (Step S1412: Yes) (Step S1401).

This allows the imaging element 100 to be set so that the imaging conditions for the entire imaging face 200 are set to the first frame rate. The imaging element 100 images the subject at the first frame rate and outputs the input video data 710 to the preprocessing unit 1210 (Step S1403).

Upon receiving the input video data 710 (Step S1403), the preprocessing unit 1210 executes the setting processing (Step S1404). The setting processing (Step S1404) sets frame rates to the respective frames of the input video data 710. For example, the image region to which the first frame rate (e.g., 30[fps]) is added is recognized as the first image region a1 while the image region to which the second frame rate (e.g., 60[fps]) is added is recognized as the second image region a2.

The preprocessing unit 1210 outputs, to the first generation unit 701, the input video data 710 (Step S1405). The preprocessing unit 1210 waits for the input of the input video data 710 of Step S1403 when the setting processing (Step S1404) does not detect the image region of the second frame rate of the next input frame (Step S1406: No). On the other hand, when the setting process (Step S1404) detects the image region of the second frame rate of the next input frame (Step S1406: Yes), then the preprocessing unit 121 changes the setting for the second image region a2 including the specific subject to the second frame rate (e.g., 60[fps]) (Step S1407).

Then, according to the setting change content of step S1407, the imaging conditions of the second imaging region among the entire imaging surface 200 are set to the second frame rate. The imaging element 100 images the subject in the first imaging region at the first frame rate and images the subject in the second imaging region at the second frame rate and outputs the input video data 710 to the preprocessing unit 1210 (Step S1409).

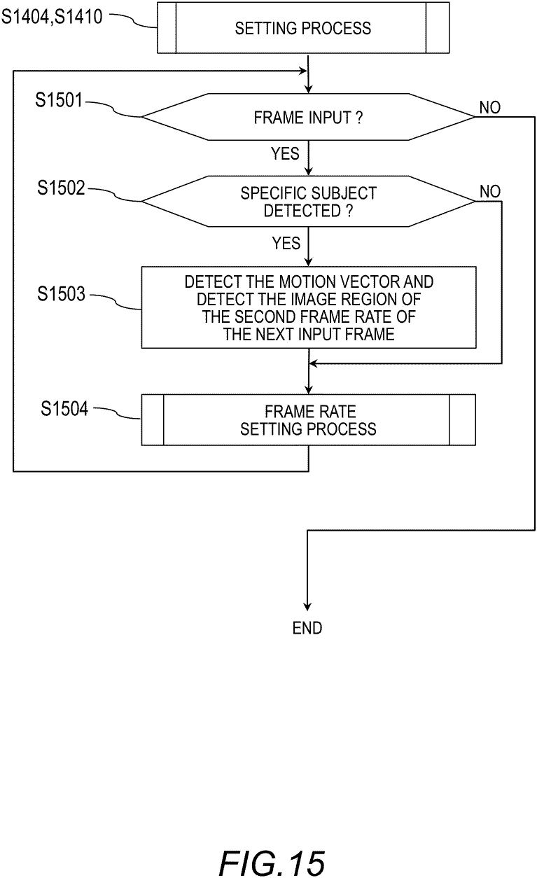

Upon receiving the input video data 710 (Step S1409), the preprocessing unit 1210 executes a setting process (Step S1410). The setting process (Step S1410) is the same process as the setting process (Step S1404). The details of the setting process (Step S1410) will be described later for FIG. 15. The preprocessing unit 1210 outputs the input video data 710 to the first generation unit 701 (Step S1411).

When no specific subject is detected (Step S1412: Yes), the preprocessing unit 1210 returns to Step S1401 to change the setting for the entire imaging face 200 to the first frame rate (Step S1401). When the specific subject is continuously detected on the other hand (Step S1412: No), then the processing returns to Step S1407 to change the second image region a2 depending on the detection position of the specific subject to the second frame rate (Step S1407). It is noted that the setting for the image region in which no specific subject is no more detected in this case is changed by the preprocessing unit 1210 to the first frame rate.

Upon receiving the the input video data 710 (Step S1405), then the first generation unit 701 execute the compensation process (Step S1413). It is noted that, in the compensation process (Step S1413), the first generation unit 701 refers to the frame rate of each frame to identify that the respective frames of the input video data 710 include the first frame 711 only.

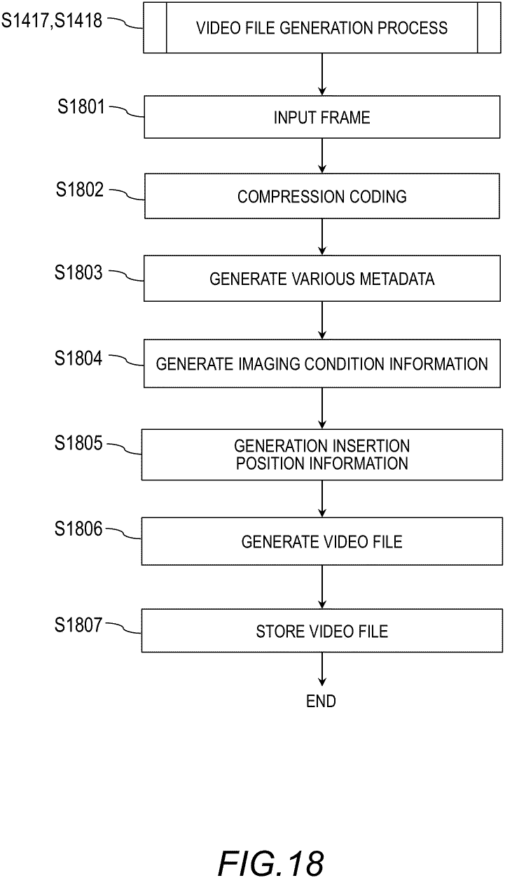

Thus, since no specific subject is imaged, the image data 712 does not exist.. Therefore, the first generation unit 701 does not compensate the image data 712. The details of the compensation process (Step S1413) will be described later for FIG. 18. The first generation unit 701 outputs the input video data 710 to the compression unit 1231 (Step S1414)

Also, upon receiving input of the input video data 710 (step S1411), the first generation unit 701 executes a compensation process (step S1415). In the compensation process (step S1415), the first generation unit 701 refers to the frame rate of each frame, and determines that each frame of the input video data 710 includes the first frame 711 and the image data 712.

Thus, the first frame 711 and the image data 712 include image of the specific subject. Thus, the first generation unit 701 generates the second frame 713. The details of the compensation process (Step S1415) will be described for FIG. 18. The first generation unit 701 outputs the first frame 711 and the image data 712 to the compression unit 1231 (Step S1416).

Upon receiving the input video data 710 (Step S1414), the compression unit 1231 and a second generation unit 1232 subjects the input video data 710 to the compression process (Step S1417). The input video data 710 is composed of the first frame 711 only. The compression unit 1231 executes a compression encoding operation not requiring a motion detection or a motion compensation in the compression process (Step S1417). The details of the compression process (Step S1417) will be described later for FIG. 18 to FIG. 24.

Also, upon receiving input of the first video data 721 and the second video data 722 (step S1416), the compression unit 1231 and the second generation unit 1232 execute a video file generation process for the first video data 721 and the second video data 722 (step S1418). The first video data 721 is constituted of the first frames 711 and the second video data 722 is constituted of the second frames 713.

If, in the video file generation process (step S1418), the item to be compressed is the first video data 721, then the compression unit 1231 executes a compression process that does not require motion detection or motion compensation for the image data of the first image region a1, and compresses image data of the second image region a2 in which the specific subject is captured by the above-mentioned hybrid encoding. In this manner, motion detection and motion compensation are not executed for regions other than the specific subject image, and thus, the processing load of video compression is reduced.

Also, even if the item to be compressed is the second video data 722, the compression unit 1231 executes a compression process that does not require motion detection or motion compensation for the image data of the compensated region 712y (black fill), and image data of the second image region a2 in which the specific subject is captured is compressed by the above-mentioned hybrid encoding. In this manner, motion detection and motion compensation are not executed for regions other than the specific subject image, and thus, the processing load of video compression is reduced. The details of the video file generation process (Step S1418) will be described later for FIG. 18 to FIG. 24.

### Setting Process (Steps S1404 and S1410)

FIG. 15 is a flowchart illustrating the detailed processing procedure example of the setting process shown in FIG. 14 (Steps S1404 and S1410). In FIG. 15, the imaging element 100 has the first frame rate (e.g., 30[fps]) in advance. The subject detection technique of the detection unit 1211 is used to track the image region having the second frame rate (e.g., 60[fps]) to feedback the result to the imaging element 100. It is noted that the image regions of the first frame rate and the second frame rate may be always fixed.

The preprocessing unit 1210 waits for the input of the frames constituting the input video data 710 (Step S1501: No). Upon receiving the input of the frames (Step S1501: Yes), the preprocessing unit 1210 judges whether or not a specific subject such as a main subject is detected by the detection unit 1211 (Step S1502). When no specific subject is detected (Step S1502: No), the processing proceeds to Step S1504.

When a specific subject is detected (Step S1502: Yes) on the other hand, the preprocessing unit 1210 uses the detection unit 1211 to compare the temporally-previous previous frame (e.g., a reference frame) with the input frame to detect a motion vector to predict the image region of the second frame rate for the next input frame to output the predicted image region to the imaging element 100 to proceed to Step S1504 (Step S1503). This allows the imaging element 100 sets the imaging conditions for the block 202 constituting the imaging region corresponding to the predicted image region to the second frame rate and sets the imaging conditions for the remaining block 202 to the first frame rate to image the subject.

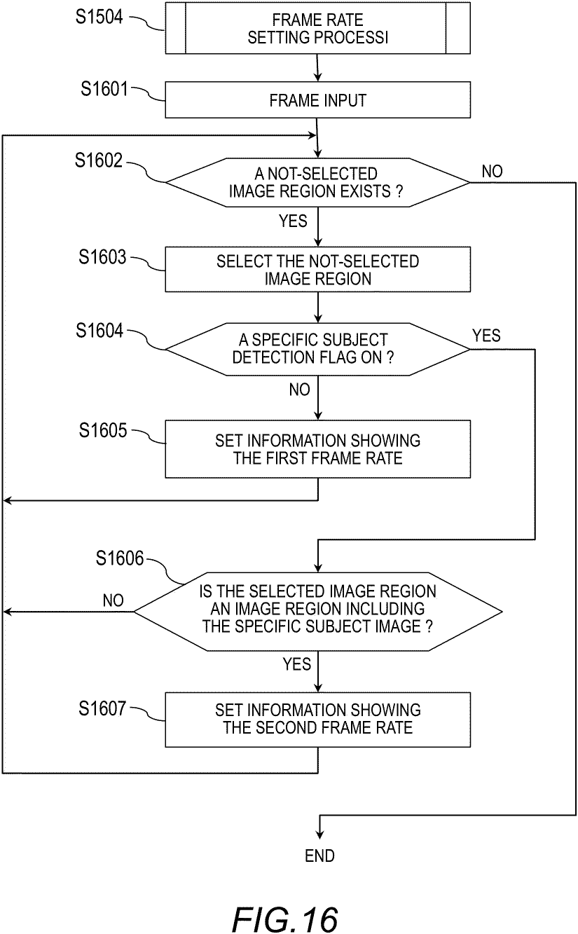

Then, the preprocessing unit 1210 executes the frame rate setting process for the input frame (Step S1504) to return to Step S1501. The frame rate setting process (Step S1504) is a process to set the above-described frame rate to the frame F, the details of which will be described for FIG. 16.

When there is no input for the frame F (Step S1501: No), the input of the input video data 710 is completed. Thus, the preprocessing unit 1210 completes the setting process (Steps S1404 and S1410).

### Frame Rate Setting Process (Step S1505)

FIG. 16 is a flowchart illustrating the detailed processing procedure example of the frame rate setting process (Step S1505) shown in FIG. 15. Upon receiving a frame (Step S1601), the preprocessing unit 1210 judges whether the input frame includes a not-selected image region or not (Step S1602). When the input frame includes a not-selected image region (Step S1602: Yes), the preprocessing unit 1210 selects one not-selected image region (Step S1603) to judge whether a detection flag is ON for a specific subject or not (Step S1604). The detection flag is information showing the existence or nonexistence of the detection of the specific subject and is set to OFF as default (non-detection).

When a specific subject is detected in Step S1406 of FIG. 14 (Step S1406: Yes), the preprocessing unit 1210 changes the detection flag from OFF to ON (detected). When no specific subject is detected in Step S1412 (Step S1412: Yes), the preprocessing unit 1210 changes the detection flag from ON to OFF.

Returning to FIG. 16, when the detection flag is OFF (Step S1604: No), the preprocessing unit 1210 sets information showing the first frame rate for the selected image region to the input frame (Step S1605) and returns to Step S1602. When the detection flag is ON (Step S1604: Yes) on the other hand, the preprocessing unit 1210 judges whether or not the selected image region is an image region including the specific subject image (Step S1606).

When there is no specific subject image (Step S1606: No), the processing returns to Step S1602. When there is a specific subject image (Step S1606: Yes) on the other hand, the preprocessing unit 1210 sets information showing the second frame rate for the selected image region to the input frame (Step S1607) to return to Step S1602.

When there is no not-selected image region in Step S1602 (Step S1602: No), the preprocessing unit 1210 completes the frame rate setting process. Thereafter, the preprocessing unit 1210 sets the frame rate to the imaging element 100 (Steps S1401 and S1407).

By setting the information showing the frame rate of each frame, the preprocessing unit 1210 can identify the imaging region of the imaging element 100 corresponding to which image region is set to which frame rate. Alternatively, the first generation unit 701 and the compression unit 1231 can identify the frame rate of each image region of the input frame F.

### Compensation Process (Steps S1413, S1415)

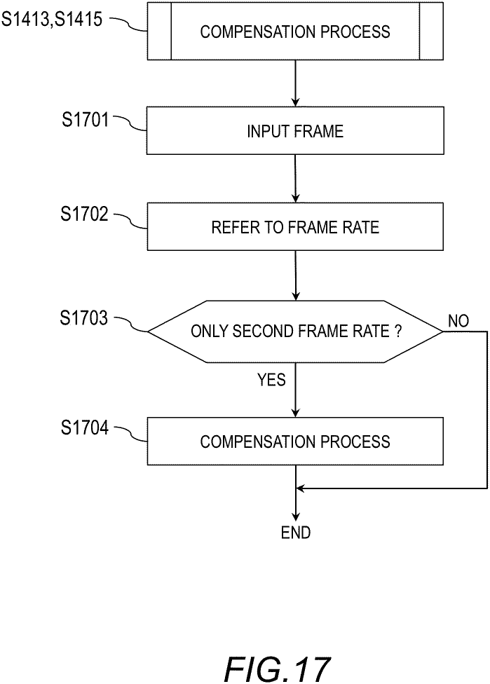

FIG. 17 is a flowchart showing an example of compensation process steps by the first generation unit 701. Upon receiving input of the frame F (step S1701), the first generation unit 701 refers to the frame rate of the input frame (step S1702). If the frame rate is not only the second frame rate (60 fps) (step S1703: No), then the first generation unit 701 ends the process without executing the compensation process. If the frame rate is only the second frame rate (60 fps) (step S1703: Yes), then the first generation unit 701 executes the compensation process and sets the input frame to the second frame 713 (step S1704). As a result, the frames F2-60 and F4-60 shown in FIG. 10 and the frames F7-60 and F9-60 shown in FIG. 11 can be generated.

### Video File Generation Process (Steps S1417, S1418)

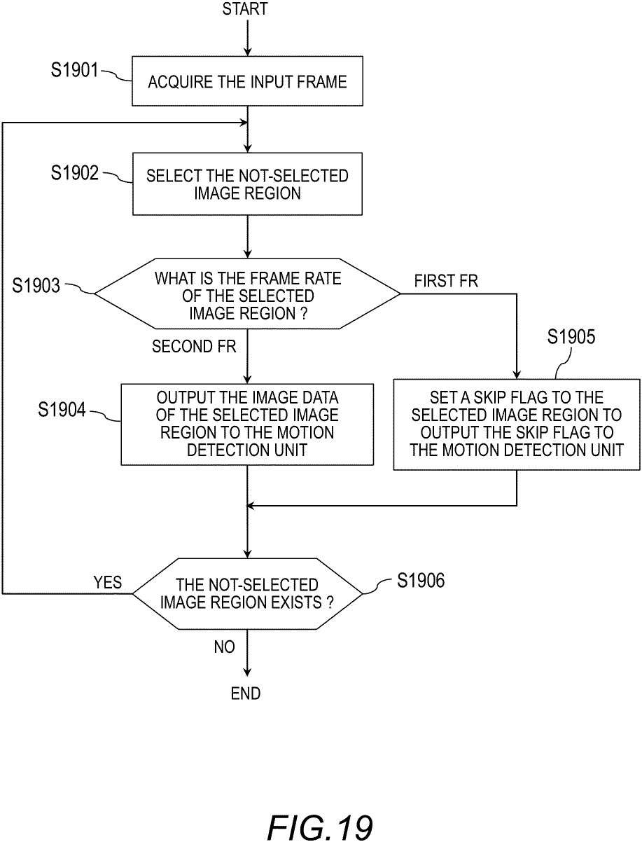

FIG. 18 is a flowchart showing an example of detailed process steps of the video file generation process (steps S1417, S1418) shown in FIG. 14. The compression unit 1231 performs the compression of the first video data 721 constituted of the first frames 711 separately from the compression of the second video data 722 constituted of the second frames 713. Upon receiving input of the frame F (step S1801), compression unit 1231 executes compression encoding of the input frame (step S1802). Details regarding the control performed for compression encoding will be described later with reference to FIGS. 19 to 24.

Then, the second generation unit 1232 generates metadata such as the uuid 831, the udta 832, the mvhd 833, and the trak 834 shown in FIG. 8 according to the compression-encoded data (step S1803). The second generation unit 1232 may execute step S1803 prior to the compression encoding (step S1802) for metadata for which information prior to compression is required.

The second generation unit 1232 refers to information indicating the frame rate applied to the frames F to generate the imaging condition information 910 (step S1804), refers to the position information of the chunks (stsz 847 and stco 848), identifies the insertion destination of the second frames 713, and generates the insertion position information (step S1805). The additional information 835 is generated by steps S1804 and S1805. The second generation unit 1232 generates the video file 800 by combining the header portion 801 and the data portion 802 (step S1806), and stores the video file in the storage device 1202 (step S1807).

### Compression Processing Example: First Compression Control Method

Next, the following section will describe the compression process by the compression unit 1231 in FIG. 18 by describing the compression process divided to the first compression control method and the second compression control method.

FIG. 19 is a flowchart illustrating the compression control process procedure example of the first compression control method by the compression control unit 1312. The compression control unit 1312 acquires an input frame (the first frame 711 or the second frame 713) (Step S1901) and selects, from the acquired input frame, a not-selected image region (Step S1902). Then, the compression control unit 1312 refers to the frame rate of the selected image region from the input frame (Step S1903).

If the input frames are the first frames 711, the selected image region is the first image region a1 outputted upon imaging at the first frame rate or the second image region a2 outputted upon imaging at the second frame rate. If the input frames are the second frames 713, the selected image region is the compensated region 712y corresponding to the first image region a1 outputted upon imaging at the first frame rate y or the second image region a2 outputted upon imaging at the second frame rate.

When the frame rate of the selected image region is the second frame rate (Step S1903: the second FR), the compression control unit 1312 outputs the image data of the selected image region to the motion detection unit 1310 (Step S1904). This allows the motion detection unit 1310 uses, with regard to the selected image region of the second frame rate, the reference frame as usual to detect a motion vector.

When the frame rate of the selected image region is the first frame rate (Step S1903: the first FR) on the other hand, the compression control unit 1312 sets a skip flag to the selected image region of the first frame rate to output the skip flag to the motion detection unit 1310 (Step S1905). This allows the motion detection unit 1310 to set, with regard to the selected image region of the first frame rate, a specific motion vector showing the nonexistence of motion.

After Step S1904 or S1905, the compression control unit 1312 judges whether or not the acquired input frame has a not-selected image region (Step S1906). When the acquired input frame has a not-selected image region (Step S1906: Yes), the processing returns to Step S1902. When the acquired input frame does not have a not-selected image region (Step S1906: No), the compression control unit 1312 completes a series of processes.

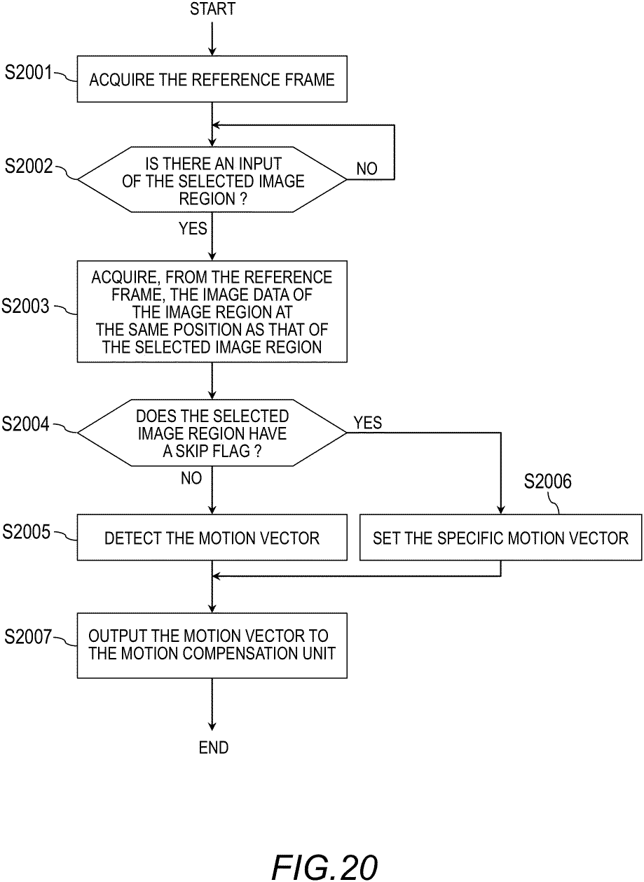

FIG. 20 is a flowchart illustrating the motion detection process procedure example of the first compression control method by the motion detection unit 1310. The motion detection unit 1310 acquires, from the frame memory 1309, the reference frame temporally previous to the input frame (Step S2001) and waits for the input of the selected image region outputted in Step S1904 or S1905 of FIG. 19 (Step S2002: No).

When the selected image region is inputted (Step S2002: Yes), the motion detection unit 1310 acquires, from the reference frame, the image data of the image region at the same position as that of the selected image region (Step S2003). Then, the motion detection unit 1310 judges whether or not the selected image region has a skip flag (Step S2004). When the selected image region does not have a skip flag (Step S2004: No), the frame rate of the selected image region is the second frame rate. Thus, the motion detection unit 1310 uses the image data of the selected image region and the image data of the image region of the reference frame acquired in Step S2003 to detect a motion vector (Step S2005).

When the selected image region has a skip flag (Step S2004: Yes) on the other hand, the motion detection unit 1310 sets a specific motion vector showing the nonexistence of a motion (Step S2006). This allows the motion detection processing by the motion detection unit 1310 to always use the specific motion vector showing the nonexistence of a motion. Thus, the selected image region of the first frame rate has a reduced motion detection processing load. Then, the motion detection unit 1310 outputs the motion vector obtained in Step S2005 or S2006 to the motion compensation unit 1311 (Step S2007) to complete a series of processes.

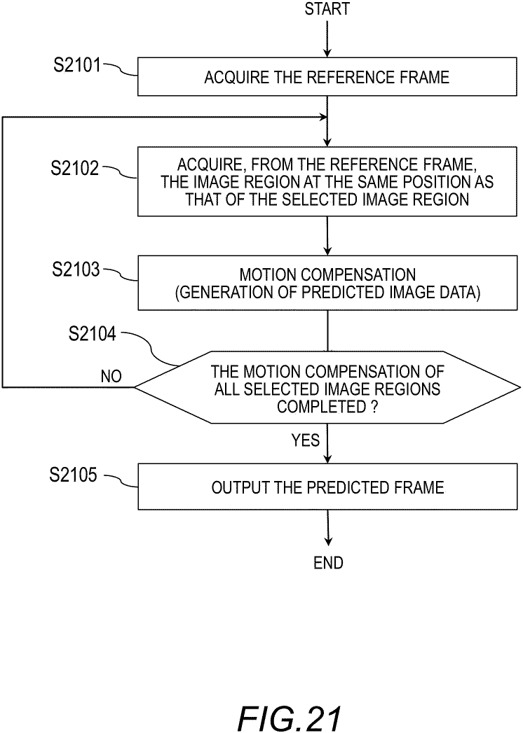

FIG. 21 is a flowchart illustrating the motion compensation process procedure example of the first compression control method by the motion compensation unit 1311. The motion compensation unit 1311 acquires a reference frame from the frame memory 1309 (Step S2101). The motion compensation unit 1311 acquires, from the reference frame, an image region at the same position as that of the selected image region (Step S2102).

Then, the motion compensation unit 1311 uses a motion vector for the selected image region from the motion detection unit 1310 and the image region of the reference frame acquired in Step S2102 to execute the motion compensation (Step S2103). This allows the motion compensation unit 1311 to generate the predicted image data in the selected image region.

Then, the motion compensation unit 1311 judges whether or not the motion compensation of all selected image regions is completed (Step S2104). Specifically, when the compression control unit 1312 judges that there is a not-selected image region in Step S1906 (Step S1906: Yes) for example, the motion compensation unit 1311 judges that all selected image regions are not yet subjected to the motion compensation (Step S2104: No). Then, the processing returns to Step S2102.

When the compression control unit 1312 judges that a not-selected image region does not exist in Step S1906 (Step S1906: No) on the other hand, the motion compensation unit 1311 judges that the motion compensation of all selected image regions is completed (Step S2104: Yes). Then, the motion compensation unit 1311 outputs, to the subtraction unit 1301 and the generation unit 1308, a prediction frame coupled with predicted image data for all selected image regions (Step S2105) and completes a series of processes.

### Compression Process Example: The Second Compression Control Method

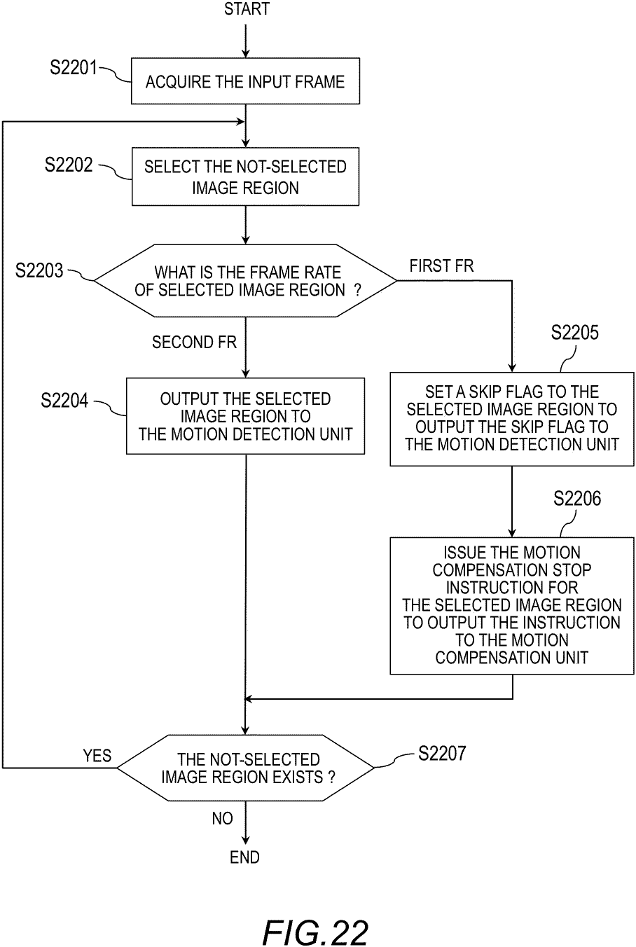

FIG. 22 is a flowchart illustrating the compression control process procedure example of the second compression control method by the compression control unit 1312. The compression control unit 1312 acquires an input frame (Step S2201) to select, from the acquired input frame, a not-selected image region (Step S2202). Then, the compression control unit 1312 refers to the frame rate of the selected image region from the input frame (Step S2203).

When the frame rate of the selected image region is the second frame rate (Step S2203: the second FR), the compression control unit 1312 outputs the selected image region to the motion detection unit 1310 (Step S2204). This allows the motion detection unit 1310 to use, with regard to the selected image region of the second frame rate, a reference frame as usual to detect a motion vector.

When the frame rate of the selected image region is the first frame rate (Step S2203: the first FR) on the other hand, the compression control unit 1312 sets a skip flag for the selected image region of the first frame rate to output the skip flag to the motion detection unit 1310 (Step S2205). This allows the motion detection unit 1310 does not execute a motion detection on the selected image region of the first frame rate. Then, the compression control unit 1312 issues the motion compensation stop instruction of the selected image region to output the motion compensation stop instruction to the motion compensation unit 1311 (Step S2206). This can consequently stop the execution of the motion compensation of the selected image region.

After Step S2204 or S2206, the compression control unit 1312 judges whether or not the acquired input frame has a not-selected image region (Step S2207). When the acquired input frame has a not-selected image region (Step S2207: Yes), the processing returns to Step S2202. When the acquired input frame does not have a not-selected image region (Step S2207: No) on the other hand, the compression control unit 1312 completes a series of processes.

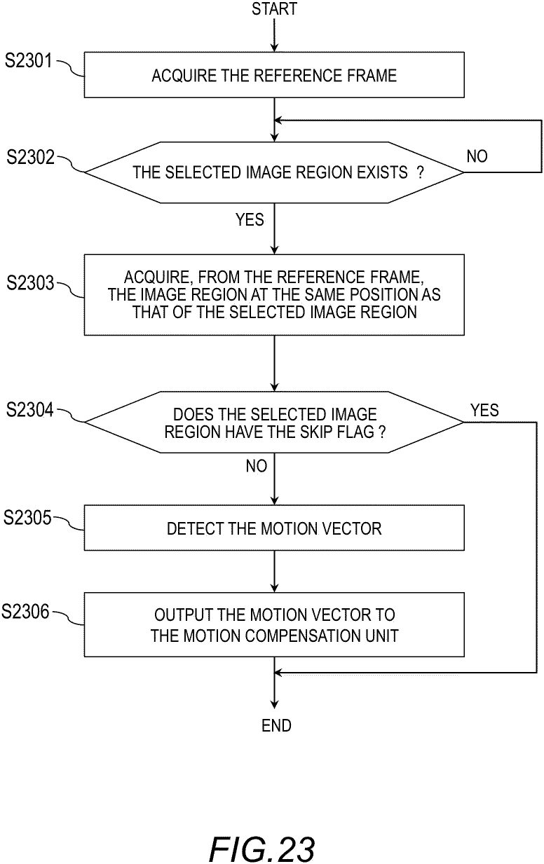

FIG. 23 is a flowchart illustrating the motion detection processing procedure example of the second compression control method by the motion detection unit 1310. The motion detection unit 1310 acquires the reference frame temporally previous to the input frame F from the frame memory 1309 (Step S2301) and waits for the input of the selected image region outputted in Step S2204 or S2205 of FIG. 22 (Step S2302: No).

Upon receiving the selected image region (Step S2302: Yes), the motion detection unit 1310 acquires, from the reference frame, the image data of the image region at the same position of that of the selected image region (Step S2303). Then, the motion detection unit 1310 judges whether or not the selected image region has a skip flag (Step S2304). When the selected image region does not have a skip flag (Step S2304: No), then the frame rate of the selected image region is the second frame rate. Thus, the motion detection unit 1310 uses the image data of the selected image region and the image data of the image region of the reference frame acquired in Step S2003 to detect a motion vector (Step S2305).

Then, the motion detection unit 1310 outputs, to the motion compensation unit 1311, the motion vector obtained in Step S2305 (Step S2306) to complete a series of processes. When the selected image region has a skip flag (Step S2304: Yes) on the other hand, the motion detection unit 1310 completes a series of processes without executing a motion detection.

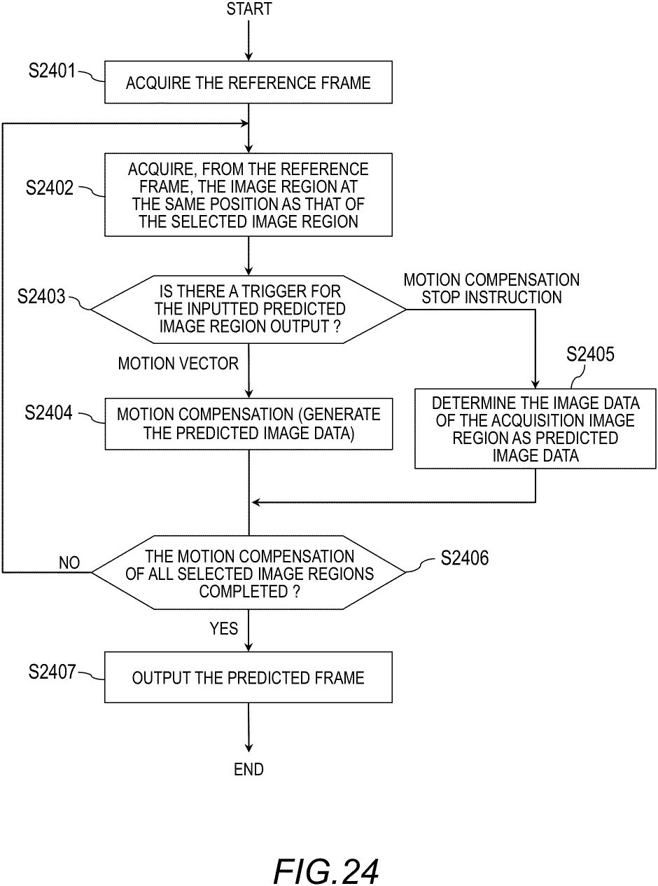

FIG. 24 is a flowchart illustrating the motion compensation processing procedure example of the second compression control method by the motion compensation unit 1311. The motion compensation unit 1311 acquires a reference frame from the frame memory 1309 (Step S2401). The motion compensation unit 1311 acquires, from the reference frame, the image region at the same position as that of the selected image region (Step S2402).

Then, the motion compensation unit 1311 judges whether or not a trigger input of the motion compensation for the selected image region is any of the motion vector or the motion compensation stop instruction (Step S2403). When the trigger input is a motion vector (Step S2403: motion vector), the motion compensation unit 1311 uses the motion vector for the selected image region from the motion detection unit 1310 and the image region of the reference frame acquired in Step S2402 to execute the motion compensation (Step S2404). This allows the motion compensation unit 1311 can generate the predicted image data in the selected image region.

When the trigger input is a motion compensation stop instruction (Step S2403: motion compensation stop instruction) on the other hand, the motion compensation unit 1311 determines the image data of the acquisition image region as the image data of the predicted image region (predicted image data) (Step S2405).

Then, the motion compensation unit 1311 judges, after Step S2404 or S2405, whether or not the motion compensation of all selected image regions is completed (Step S2406). Specifically, when the compression control unit 1312 judges that there is a not-selected image region in Step S2207 for example (Step S2007: Yes), the motion compensation unit 1311 judges that the motion compensation of all selected image regions is not completed (Step S2406: No) and the processing returns to Step S2402.

When the compression control unit 1312 determines in Step S2207 that a not-selected image region does not exist (Step S2207: No) on the other hand, the motion compensation unit 1311 judges that the motion compensation of all selected image regions is completed (Step S2406: Yes). Then, the motion compensation unit 1311 outputs, to the subtraction unit 1301 and the generation unit 1308, a prediction frame coupled with the predicted image data for all selected image regions (Step S2407) and completes a series of processes.

### Process From Decompression to Playback

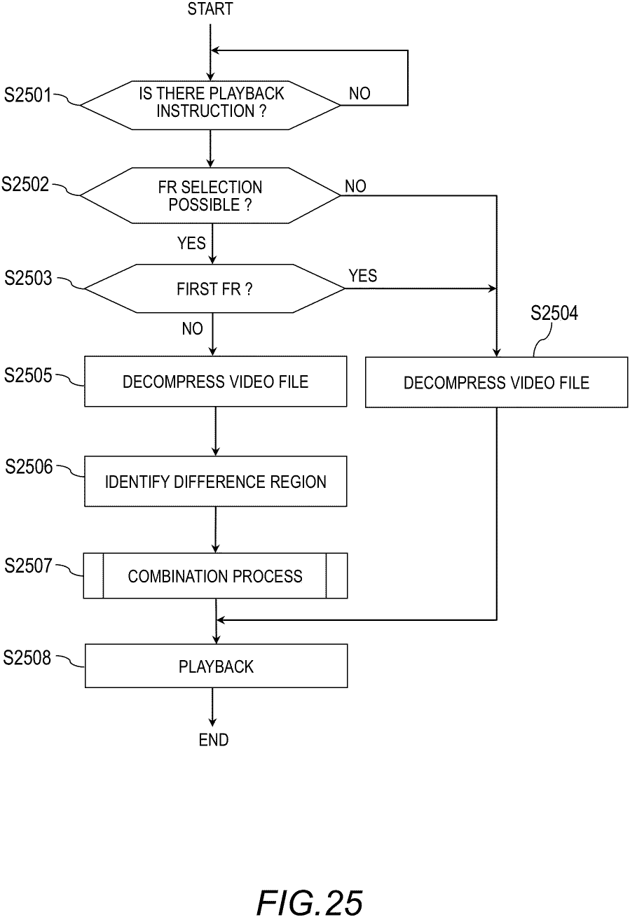

FIG. 25 is a flowchart showing an example of process steps from decompression to playback. The selection unit 1233 awaits selection of the playback instruction from the operation unit 505 (step S2501: No), and if there has been a selection instruction (step S2501: Yes), then the selection unit 1233 determines whether the frame rate of the video file 800 to be played back can be selected (step S2502). If the frame rate is not selectable (step S2502: No), then the video file 800 is one in which frame groups at only the first frame rate (30 fps) are selected. In this case, the decompression unit 1234 decompresses the video file 800 (step S2504) and progresses to step S2508.

On the other hand, if the frame rate is selectable (step S2502: Yes), then the selection unit 1233 determines whether the selected frame rate is the first frame rate (30 fps) (step S2503). If the first frame rate (30 fps) is selected (step S2503: Yes), then the video file 800 to be played back is one in which the first video data 721 is compressed. Thus, the decompression unit 1234 decompresses the video file 800 (step S2504) and progresses to step S2508.

On the other hand, if the second frame rate (60 fps) is selected (step S2503: No), then the video file 800 to be played back is one in which the first video data 721 and the second video data 722 are compressed. Thus, the decompression unit 1234 decompresses the video file 800 and outputs the first video data 721 and the second video data 722 (step S2505).

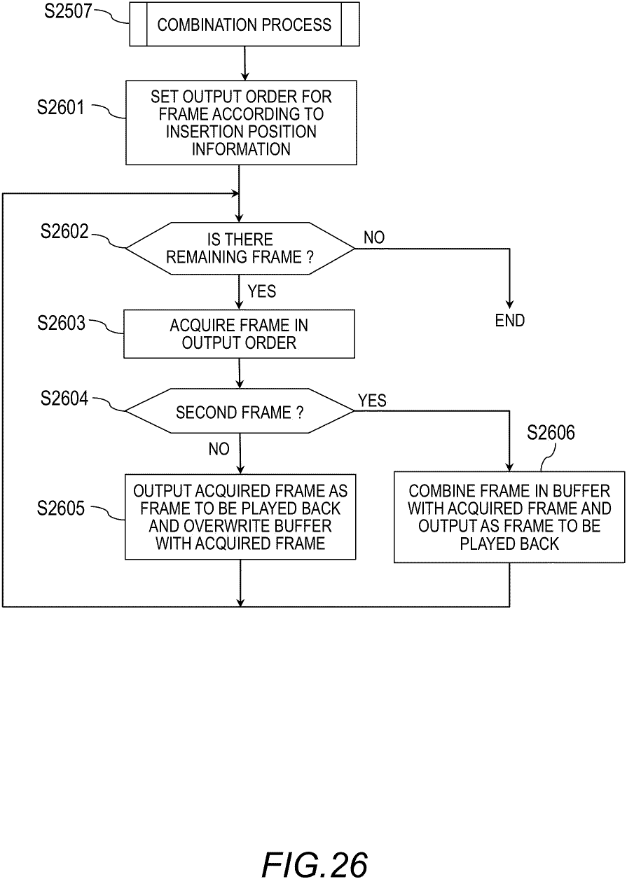

Also, the identification unit 1240 identifies the difference region with reference to the first video data 721 and the second video data 722 decompressed in step S2505 (step S2506). Thereafter, the combination unit 703 causes the combination process to be executed on the first video data 721 and the second video data 722 as shown in FIGS. 10 and 11 (step S2507). Details regarding the combination process (step S2507) will be described later with reference to FIG. 26. Lastly, the playback unit 704 plays back the video data attained in the combination process (step S2507) or step S2504 in a liquid crystal monitor (step S2508).

### Combination Process (Step S2507)

FIG. 26 is a flowchart showing an example of detailed process steps of the combination process (step S2507) shown in FIG. 25. The combination unit 703 sets the output order for the frames F according to the insertion position information 920 (step S2601). Next, the combination unit 703 determines whether there are remaining frames that have yet to be outputted to the playback unit 704 (step S2602). If there are remaining frames (step S2602: Yes), the combination unit 703 acquires the frames in the output order (step S2603).

The combination unit 703 refers to the frame type identification information written to the uuid 831 to determine whether the acquired frame is the second frame 713 (step S2604). If the acquired frame is not the second frame 713 (step S2604: No), then the acquired frame is the first frame 711, and thus, the combination unit 703 outputs the acquired frame to the playback unit 704 to be played back and writes the frame to the buffer (step S2605). Thereafter, the process returns to step S2602.

On the other hand, if in step S2604, the acquired frame is the second frame 713 (step S2604: Yes), then the combination unit 703 combines the frame in the buffer with the acquired frame to generate the third frame 730 and outputs the third frame to the playback unit 704 to be played back (step S2606). Thereafter, the process returns to step S2602. In step S2602, if there are no frames remaining (step S2602:No), then the combination unit 703 ends the combination process (step S2507).

As a result, the combination unit 703 uses the second frame 713 and the immediately preceding first frame 711 to form a combined third frame 730 including the first image region a1 and the second image region a2 as shown in FIGS. 10 and 11. Thus, it is possible to absorb the frame rate difference in each frame.

1) Thus, the video compression apparatus generates a plurality of first frames on the basis of the data outputted from the first imaging region, and generates a plurality of second frames on the basis of the data outputted from the second imaging region, to compress the plurality of first frames 711 and the plurality of second frames 713. As a result, when compressing video data with differing frame rates for the image regions, it is possible to separately compress the video data.

2) Also, in 1), the video compression apparatus generates the first frames 711 on the basis of the data outputted from the first imaging region and data outputted from the second imaging region. As a result, it is possible to generate frames with no loss by outputting from the plurality of imaging regions.

3) Also, in 1), the video compression apparatus generates the second frames 713 on the basis of the data outputted from the second imaging region and data not based on output from the imaging element 100. As a result, data not based on the output from the imaging element 100 is attained from image processing of the loss region 712x instead of data from the first imaging region, for example. Thus, it is possible to compress the second frames 713 in the same manner as the first frames 711.

4) Also, in 3), the video compression apparatus generates the second frames 713 on the basis of the data outputted from the second imaging region and prescribed data. The prescribed data is data attained from image processing of the loss region 712x, for example. Thus, it is possible to compress the second frames 713 in the same manner as the first frames 711.

5) Also, in 4), the video compression apparatus generates the second frames 713 for data outputted from the second imaging region by compensating the regions where data was not outputted from the first imaging region (loss region 712x). As a result, it is possible to compress the second frames 713 in the same manner as the first frames 711 by compensating the loss region 712x.

6) Also, in 5), the video compression apparatus generates the second frames 713 by compensating the region where data from the first imaging region was not outputted with a specific color for the data outputted from the second imaging region. As a result, it is possible to improve the compression efficiency.

7) Also, in 3)-6), the video compression apparatus detects the motion vectors for image data in the region generated on the basis of the data outputted from the second imaging region among the second frames. As a result, by setting a specific motion vector instead of detecting a motion vector for the image data of the first image region a1 and the compensated region 712y, for example, it is possible to reduce the load of the compression process by not executing motion detection.

8) Also, in 7), the video compression apparatus does not detect motion vectors for image data in a region other than the region generated on the basis of the data outputted from the second imaging region. As a result, for example, it is possible to reduce the load of the compression process by not executing motion detection for image data of the first image region a1 and the compensated region 712y.

9) Also, in 7) or 8), the video compression apparatus executes motion compensation on the basis of the motion vector detection results. As a result, it is possible to reduce the load of the compression process.

Thus, according to the above-mentioned video compression apparatus, it is possible to compress the first video data 721 constituted of the first frames 711 separately from the compression of the second video data 722 constituted of the second frames 713 that were subjected to compensation. That is, it is possible to differentiate the compression of the input video data 710 in which differing frame rates coexist according to the imaging timing of the frame rate.

Thus, when decompressing or performing playback, it is possible to select the first video data 721 or both the first video data 721 and the second video data 722 to be decompressed or played back. If performing playback at 30 fps, which is the imaging timing for the first frames 711, for example, only the first video data 721 need be decompressed and played back.

As a result, decompression processing of the second video data 722 is unnecessary, and it is possible to increase the speed and reduce energy consumption of the decompression process of the video data to be played back. Also, if performing playback at 60 fps, which is the imaging timing for the image data 712, for example, both the first video data 721 and the second video data 722 would be decompressed and combined. As a result, it is possible to increase the reproducibility of the subject video as necessary and play back more realistic footage.

1) Also, the generation apparatus includes: a generation unit (second generation unit 1232) that generates a video file 800 including first compressed data in which the plurality of first frames 711 generated on the basis of data outputted from the first imaging region set at the first frame rate (30 fps, for example) are compressed, second compressed data in which the plurality of second frames 713 generated on the basis of data outputted from the second imaging region set at the second frame rate (60 fps, for example), which is faster than the first frame rate, are compressed, first position information indicating the storage position of the first compressed data, and second position information indicating the storage position of the second compressed data; and the storage unit 1235, which stores the video file 800 generated by the generation unit in the storage device 1202.

As a result, by compressing, by a common compression method, the compressed video data of the first frames 711 and the second frames 713 having differing imaging timings, it is possible to combine the video data into one video file 800.

2) Also, in the generation apparatus of 1), the first frames 711 may be generated on the basis of the data outputted from the first imaging region and data outputted from the second imaging region.

As a result, by compressing, by a common compression method, the compressed data of the first frames 711 imaged at the imaging timing of the first frame rate and the compressed data of the second frames 713 imaged at the imaging timing of the second frame rate, it is possible to combine the compressed data into one video file 800.

3) Also, in the generation apparatus of 1), the second frame 713 may be generated on the basis of the data outputted from the second imaging region and data not based on output from the imaging element 100.

As a result, even if there were an image region that is not outputted at the imaging timing of the second frame rate (loss region 712x), by handing the data outputted from the second imaging region as the second frames 713, it is possible to compress the data by the same compression method as that for the first frames 711.

4) Also, in the generation apparatus of 3), data not based on output from the imaging element 100 may be the prescribed data. As a result, it is possible to form the second frames 713 from data unrelated to the output from the imaging element 100, and it is possible to compress the second frames by the same compression method as that for the first frames 711.

5) Also, in the generation apparatus of 4), the second frames 713 may be generated for data outputted from the second imaging region by compensating the loss region 712x where data was not outputted from the first imaging region. As a result, in the second frames 713, the loss region 712x not outputted at the imaging timing of the second frame rate is compensated to form the compensated region 712y, and thus, it is possible to compress the data by the same compression method as that for the first frames 711.

6) In the generation apparatus of 1), the generation unit sets the first compressed data and the second compressed data in the data portion 802 and sets the first position information and the second position information in the header portion 801 to generate the video file 800 including the data portion 802 and the header portion 801. As a result, it is possible to read the compressed data of the data portion 802 by referring to the header portion 801.

7) Also, in the generation apparatus of 5), the generation unit sets the first frame rate information indicating the first frame rate (“30 fps” in 911) in association with the first position information (Pa in 912) in the header portion 801, and sets the second frame rate information indicating the second frame rate (“60 fps” in 911) in association with the first position information (Pa in 912) and the second position information (Pb in 912), thereby generating the video file 800 including the header portion 801 and the data portion 802.

As a result, it is possible to read the compressed data of the first video data 721 identified by the first position information associated with the first frame rate information, or to read the first compressed video data in which the first video data 721 identified by the first position information associated with the first frame rate information is compressed and the second compressed video data in which the second video data 722 identified by the second position information associated with the second frame rate information is compressed.

Thus, if the first frame rate is selected, then it is possible to reliably call the first compressed video data in which the first video data 721 is compressed from the video file 800. Also, if the second frame rate is selected, then it is possible to reliably call the second compressed video data in which the second video data 722 is compressed from the video file 800. Additionally, if the first frame rate is selected, then it is possible to mitigate the occurrence of missed calls of the first compressed video data from the video file 800.

8) Also, in the generation apparatus of 7), the second generation unit 1232 sets, in the header portion 801, information indicating the insertion destination in the first frames 711 to which to insert the second frames 713 (insertion position information 920), thereby generating the video file 800 including the header portion 801 and the data portion 802.

As a result, it is possible to increase the accuracy at which the first video data 721 and the second video data 722 are combined, increase the reproducibility of the subject video as necessary, and play back more realistic footage.

9) Also, in the generation apparatus of 3), the generation unit may generate a video file 800 for each of the first video data 721 and the second video data 722, and associate both video files 800 with each other. As a result, it is possible to distribute only the video file 800 of the first video data 721. If playback at the second frame rate is desired, then the video file 800 of the second video data 722 would be separately acquired.

In this manner, by generating separate video files 800 for the first video data 721 and the second video data 722, it is possible to distribute (such as by downloading) the video file 800 according to conditions. For example, it is possible to achieve a configuration in which the device of a user who is using a free version of a video distribution service can only download the video file 800 of the first video data 721, whereas the device of a user who is using a paid version of the video distribution service can download both video files 800.

1) Also, a playback apparatus has: a decompression unit that reads a video file including first compressed data in which the plurality of first frames 711 generated on the basis of data outputted from the first imaging region set at the first frame rate are compressed and second compressed data in which the plurality of second frames 713 generated on the basis of data outputted from the second imaging region set at the second frame rate, which is faster than the first frame rate, are compressed, the decompression unit decompressing at least the first compressed data among the first and second compressed data; and a playback unit 704 that plays back the plurality of frames decompressed by the decompression unit 1234.

Thus, it is possible to select the first video data 721 or both the first video data 721 and the second video data 722 to be played back. If performing playback at 30 fps, which is the imaging timing for the first frames 711, for example, only the plurality of first frame 711 need be played back.

As a result, excess playback processing of the plurality second frame 713 becomes unnecessary, and it is possible to reduce energy consumption. Also, if performing playback at 60 fps, which is the imaging timing for the image data 712, for example, both the first video data 721 and the second video data 722 would be played. As a result, it is possible to increase the reproducibility of the subject video as necessary and play back more realistic footage.

2) Also, in the playback apparatus of 1), the first frames 711 may be generated on the basis of the data outputted from the first imaging region and data outputted from the second imaging region.

As a result, the compressed data of the first frames 711 imaged at the imaging timing of the first frame rate and the compressed data of the second frames 713 imaged at the imaging timing of the second frame rate are compressed by the same compression method to generate the video file 800, and thus, by decompressing the video file 800, it is possible to select the first video data 721 or both the first video data 721 and the second video data 722 to be played back.

3) Also, in the playback apparatus of 1), the second frame 713 may be generated on the basis of the data outputted from the second imaging region and data not based on output from the imaging element 100.

As a result, even if there were an image region that is not outputted at the imaging timing of the second frame rate (loss region 712x), by handing the data outputted from the second imaging region as the second frames 713, the data is compressed by the same compression method as for the first frames 711 to generate the video file 800, and thus, by decompressing the video file 800, it is possible to play back the video at the first frame rate or the second frame rate.

4) Also, in the playback apparatus of 3), data not based on output from the imaging element 100 may be the prescribed data. As a result, the second frame 713, formed using data unrelated to the output from the imaging element 100, and the first frame 711 are compressed by the same compression method to generate the video file 800, and thus, by decompressing the video file 800, it is possible to play back the first video data 721 and the second video data 722 in combination when playing the video file back at the second frame rate.

5) Also, in the playback apparatus of 4), the second frames 713 may be generated for data outputted from the second imaging region by compensating the loss region 712x where data was not outputted from the first imaging region. As a result, when performing playback at the second frame rate, it is possible to play back both the first video data 721 and the second video data 722 in combination with each other.

6) Also, the playback apparatus of 1) includes a selection unit 1233 that selects the frame rate at which to perform playback, and the decompression unit 1234 decompresses the first compressed data and the second compressed data on the basis of the frame rate selected by the selection unit 1233. As a result, it is possible to play back both the first video data 721 and the second video data 722 by selecting the desired frame rate for playback.

7) Also, in the playback apparatus of 6), if the first frame rate is selected by the selection unit 1233, the decompression unit 1234 decompresses the first compressed data, and if the second frame rate is selected by the selection unit 1233, the decompression unit 1234 decompresses the first compressed data and the second compressed data. As a result, it is possible to change the data being played back according to the selected frame rate.

Thus, it is possible to select the first compressed video data or both the first compressed video data and the second compressed video data to be decompressed. If performing playback at 30 fps, which is the imaging timing for the first frames 711, for example, only the first compressed video data need be decompressed to play back the first video data 721.

As a result, decompression processing of the second compressed video data is unnecessary, and it is possible to reduce energy consumption. Also, if performing playback at 60 fps, which is the imaging timing for the image data 712, for example, both the first compressed video data and the second compressed video data would be decompressed to play back the first video data 721 and the second video data 722. As a result, it is possible to increase the reproducibility of the subject video as necessary and play back more realistic footage.

### Embodiment 2

Embodiment 2 will be described next. In Embodiment 1, compensated image sections Da1, Da3, etc. are present in the frames F2, F4, etc. shown in FIG. 10, and thus, these ranges are either filled in with a specific color or are subjected to demosaicing. In Embodiment 2, the combination unit 703 generates the frames F2, F4, etc. with a more natural appearance without performing such image processing. In Embodiment 2, components in common with Embodiment 1 are assigned the same reference characters and descriptions thereof are omitted.

### Combination Example of Frame

The following section will describe the combination example of the frame F. In FIG. 10, the combination process example 1 is described in which the electronic apparatus 500 photographs a running railway train as a specific subject during a fixed point photographing of the scenery including a rice field, mountain, and sky. The following section will specifically describe the flow of the process of the combination process example 1.

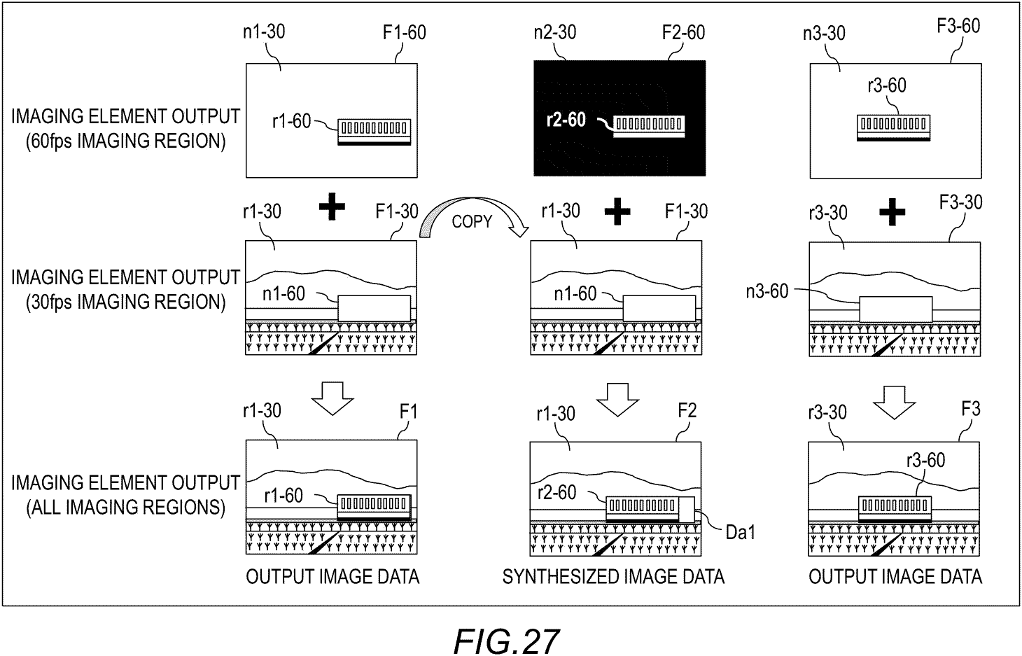

FIG. 27 illustrates the flow of the identification processing of the combination process example 1 shown in FIG. 10. As has been described for FIG. 10, the imaging element 100 outputs the frames F1, F2-60, F3,... in the order of time scales. It is assumed that the railway train runs from right to left within the frames F1, F2-60, and F3.

In FIG. 27, the branch numbers of the frames F1-F3 show the frame rates of the frames F1-F3. For example, the odd-numbered frame F1-30 shows the image data of the first image region r1-30 of the frame F1 imaged at the frame rate of 30[fps]. The frame F1-60 shows the image data of the second image region r1-60 of the frame F1 imaged at the frame rate of 60[fps].

The frame F1-60 has the second image region r1-60 imaged at the frame rate of 60[fps] that has the image data of the railway train. However, the frame F1-30 does not include the second image region r1-60. Such a region in the frame F1-30 is called a non-image region n1-60. Similarly, in the case of the frame F1-60, the first image region r1-30 of the frame F1-30 imaged at the frame rate of 30[fps] has the scenery image data. However, the frame F1-60 does not have the scenery image data in the second image region r1-60. Such a region in frame F1-60 is called a non-image region n1-30.

Similarly, in the case of the frame F3, the frame F3-30 is composed of the first image region r3-30 to which the scenery image data is outputted and the non-image region n3-60 to which nothing is outputted. The frame F3-60 is composed of the second image region r3-60 to which the image data of the railway train is outputted and the non-image region n3-60 to which nothing is outputted. This also applies to odd-numbered frames after the frames F3-30 and F3-60 (not shown).

Also, even-numbered frames F2-60 are second frames 713 constituted of image data (train) of a second image region r2-60 outputted upon imaging at a frame rate of 60 fps, and a compensated region 712y filled in with a specific color (such as black). This also applies to following even-numbered frames (not shown).

The combination unit 703 combines the image data of the second image region r2-60 of the frame F2-60 (railway train) and the image data of the first image region r1-30 of the frame F1-30 (scenery) to thereby generate the frame F2 as combined image data. In this case, as has been described for FIG. 10, the frame F2 has the compensated image portion Da1 in which the non-image region n1-60 of the frame F1-30 and the compensated region 712y of the frame F2-60 compensated from the non-image region n2-30 are overlapped.

In the illustrative embodiment 1, the combination unit 703 paints thecompensated image portion Da1 with a specific color or subjects the compensated image portion Da1 to the demosaic process. However, in the illustrative embodiment 2, the combination unit 703 copies the image data of the compensated image portion Da1 in another image region without executing such an image processing. This allows the combination unit 703 to generate the frame F2 causing a reduced sense of incongruity. This also applies to the compensated image portion Da3 and will be described by paying attention on the compensated image portion Da1 in the illustrative embodiment 2.

### Combination Example of Frame F2

Next, the following section will describe the combination example of the frame F2 by the combination unit 703.

### Combination Example 1

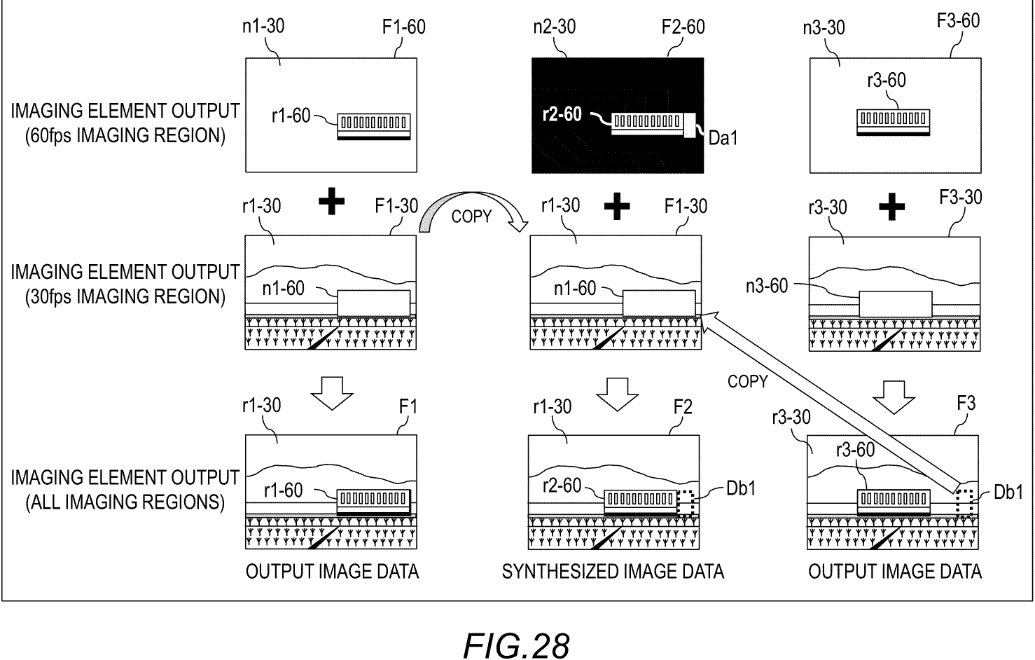

FIG. 28 illustrates the combination example 1of the frame F2 of 60[fps] according to illustrative embodiment 2. The combination example 1 is an example to use, as another image region as a copy target to the compensated image portion Da1, the compensated image portion Db1 at the same position as that of the compensated image portion Da1 in the first image region r3-30 of the frame F3 temporally after the frame F2-60. The image data of the compensated image portion Db1 is a part of the scenery.

In FIG. 28, the combination unit 703 identifies the compensated image portion Da1 in which the non-image region n1-60 of the frame F1-30 and the compensated region 712y of the frame F2-60 compensated from the non-image region n2-30 are overlapped to identify, from the frame F3, the compensated image portion Db1 at the same position as that of the identified compensated image portion Da1. Then, the combination unit 703 copies the image data of the compensated image portion Db 1 to the compensated image portion Da1 in the frame F2. This allows the combination unit 703 can generate the frame F2 causing a reduced sense of incongruity.

### Combination Example 2

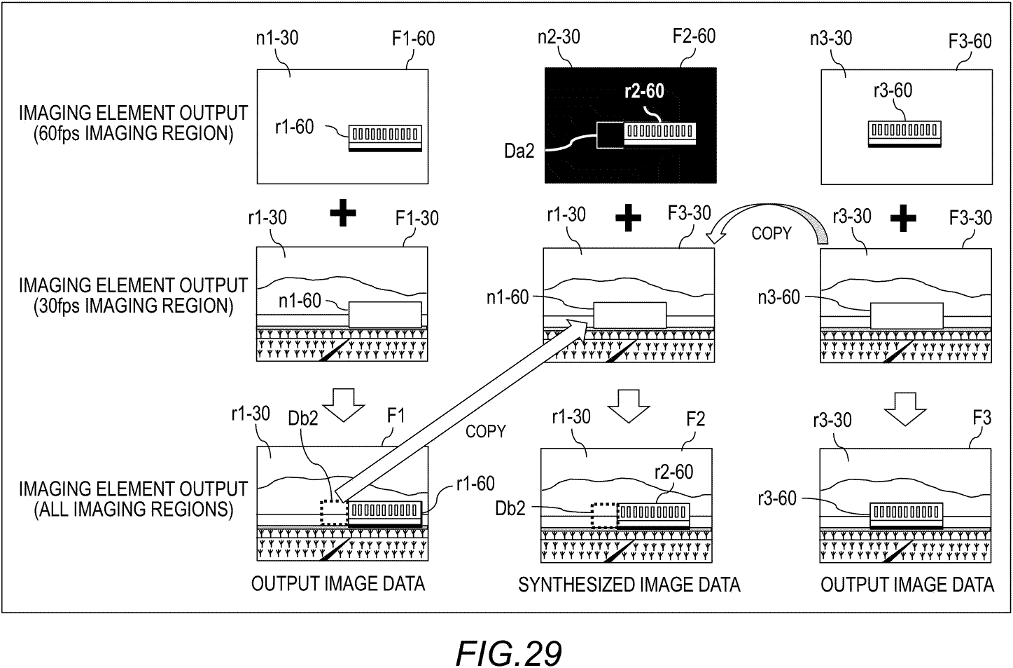

FIG. 29 illustrates the combination example 2 of the frame F2 of 60[fps] according to illustrative embodiment 2. In the combination example 1, the image data of the first image region r1-30 of the frame F1-30 is a copy source to the first image region of the frame F2 and the image data of frame F3 is a copy source to the compensated image portion Da1. However, in the combination example 2 has an inverse configuration in which the image data of the first image region r3-30 of the frame F3-30 is a copy source to the first image region of the frame F2 and the image data of the compensated image portion Db2 of the frame F1 is a copy source to the compensated image portion Da2.

The compensated image portion Da2 is a range in which the non-image region n3-60 of the frame F3-30 and the compensated region 712y of the frame F2-60 compensated from the non-image region n2-30 are overlapped. The range Db2 of the frame F1 is a range at the same position as that of the range Da2.

In FIG. 29, the combination unit 703 identifies the compensated image portion Da2 in which the non-image region n3-60 of the frame F3-30 and compensated region 712y of the frame F2-60 compensated from the non-image region n2-30 are overlapped to identify, from the frame F1, the compensated image portion Db2 at the same position as that of the identified compensated image portion Da2. Then, the combination unit 703 copies the compensated image portion Db2 to the image data of the compensated image portion Da2 in the frame F2. This allows the combination unit 703 to generate the frame F2 causing a reduced sense of incongruity.

### Combination Example 3

The combination example 3 is an example in which any one of the combination example 1 and the combination example 2 is selected and combined. In the combination example 3, the combination unit 703 identifies the compensated image portion Da1 in the combination example 1 and the compensated image portion Da2 in the combination example 2. The combination unit 703 selects any one of the compensated image portions Da1 and Da2 to use the combination example in which the selected compensated image portion is identified. The combination unit 703 uses the combination example 1 when the compensated image portion Da1 is selected and uses the combination example 2 when the compensated image portion Da2 is selected.

The combination unit 703 uses the narrowness of the compensated image portion as a selection reference to select any one of the compensated image portions Da1 and Da2. In the examples of FIG. 28 and FIG. 29, the compensated image portion Da1 is narrower than the compensated image portion Da2 and thus the combination example 1 is applied to the compensated image portion Da1. By selecting a narrower compensated image portion, the sense of incongruity due to copying can be minimized.

### Combination Example 4

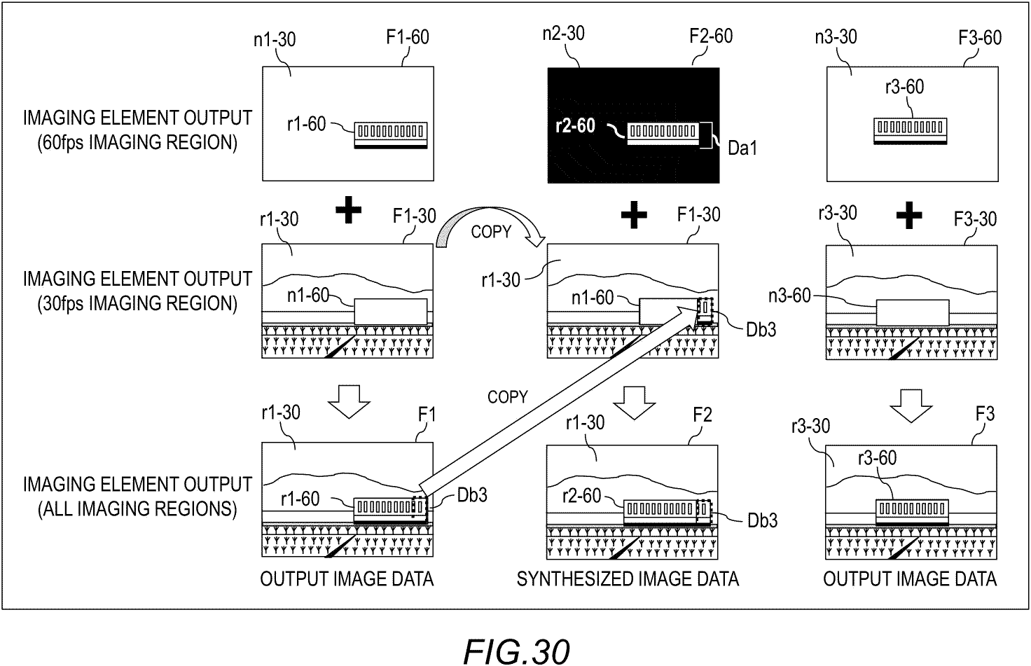

FIG. 30 illustrates the combination example 4 of the frame F2 of 60[fps] according to illustrative embodiment 2. The combination example 4 sets the copy source of the compensated image portion Da1 in the combination example 1 not to the image data of the compensated image portion Db1 in the first image region r3-30 of the frame F3 (a part of the scenery) but to the image data of the compensated image portion Db3 in the second image region r1-60 of the frame F1 (the end of the railway train).

This allows the image data of the second image region r2-60 in the frame F2 (railway train) is added with the image data of the compensated image portion Db3. However, the image data of the compensated image portion Db3 is added in an opposite direction to the direction along which the image data of the second image region r2-60 (railway train) proceeds. Thus, when the user sees the video, the user misapprehends that the image data of the second image region r2-60 (railway train) is the afterimage of the running railway train. Thus, the frames F2, F4,... causing a reduced sense of incongruity can be also generated in this case.

### Combination Process Procedure Example of Frame F2

The following section will describe the combination process procedure example of the frame F2 according to the above-described combination example 1 to combination example 4. In the flowchart below, the second frames 713 are outputted upon imaging only at the second frame rate (60 fps, for example) for combination, and the loss region 712x is filled in with the specific color (black). The frame F2-60 of FIGS. 27 to 30 is the second frame 713, for example.

The first frame is a frame that is temporally previous to the second frame and that includes an image region imaged at at least the first frame rate among the first frame rate (e.g., 30[fps]) and the second frame rate (e.g., frame F1 of FIGS. 27 to 30).

Also, the third frames 730 are formed by combining the second frames 713 with the first frames 711 or the third frames 730. The frame F2 of FIGS. 27 to 30 is the third frame 730, for example.

The fourth frame is a frame that is temporally after the second frame 713 and that includes an image region imaged at at least the first frame rate among the first frame rate and the second frame rate (e.g., frame F3 of FIG. 25 to FIG. 28).

### Combination Example 1

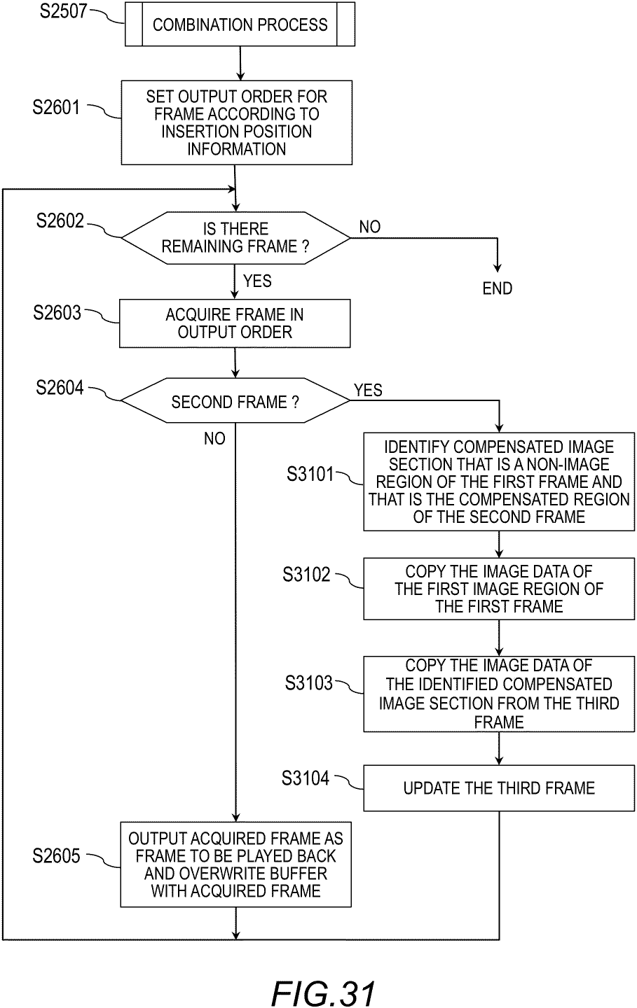

FIG. 31 is a flowchart illustrating the combination process procedure example 1 by the combination example 1 of the frame F2 by the combination unit 703. Steps that are the same as those in FIG. 26 are assigned the same step numbers and explanations thereof are omitted.

In step S2604, if the acquired frame is the second frame 713 (step S2604: Yes), then the identification unit 1240 identifies a range that is a non-image region in the first frame 711 and is the compensated region 712y in the second frame 713 (step S3101). Specifically, for example, as shown in FIG. 28, the identification unit 1240 identifies a compensated image portion Da1 in which a non-image region n1-60 of the frame F1-30 overlaps the compensated region 712y of the frame F2-60 in which a non-image region n2-30 was compensated.

Next, the combination unit 703 copies the image data of the first image region a1 of the first frame 711 (Step S3102). Specifically, the combination unit 703 copies the image data of the first image region r1-30 of the frame F1 (scenery) for example, as shown in FIG. 28.

Then, the combination unit 703 copies, from the fourth frame, the image data of the range identified in Step S3101 (Step S3103). Specifically, the combination unit 703 copies, from the frame F3, the image data of the same compensated image portion Db 1 as the compensated image portion Da1 identified in Step S3101 for example, as shown in FIG. 28.

Next, the combination unit 703 generates the third frame by combination (Step S3104). Specifically, the combination unit 703 combines the second image region r2-60 of the frame F2-60, the copied image data the first image region r1-30 (scenery), and the copied image data of the compensated image portion Db1 to thereby update the frame F2-60 as the frame F2 for example, as shown in FIG. 28.

Thereafter, the processing returns to Step S2602. When the buffer does not have remaining frames (Step S2602: No), the combination unit 703 completes the combination process (Step S2507). This allows the combination unit 703 to generate the frame F2 causing a reduced sense of incongruity, as shown in FIG. 28.

### Combination Example 2

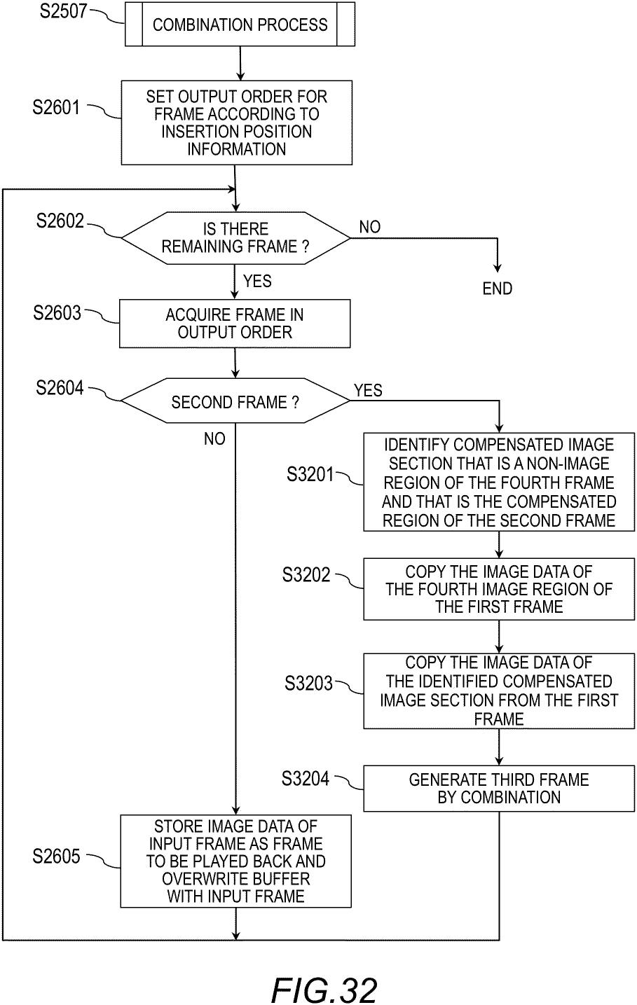

FIG. 32 is a flowchart illustrating the combination process procedure example 2 by the combination example 2 of the frame F2 by the combination unit 703. Steps that are the same as those in FIG. 26 are assigned the same step numbers and explanations thereof are omitted.

In step S2604, if the acquired frame is the second frame 713 (step S2604: Yes), then the identification unit 1240 identifies a range that is a non-image region in the fourth frame and is the compensated region 712y in the second frame 713 (step S3101). Specifically, for example, as shown in FIG. 29, the identification unit 1240 identifies a compensated image portion Da1 in which a non-image region n1-60 of the frame F1-30 overlaps the compensated region 712y of the frame F2-60 in which a non-image region n2-30 was compensated.

Next, the combination unit 703 copies the image data of the first image region a1 of the fourth frame (Step S3202). Specifically, for example, as shown in FIG. 29, the combination unit 703 copies the image data of the first image region r3-30 of the frame F3 (scenery).

Then, the combination unit 703 copies, from the first frame 711, the image data of the range identified in Step S3201 (Step S3203). Specifically, for example, as shown in FIG. 29, the combination unit 703 copies, from the frame F1, the image data of the same compensated image portion Db2 as the compensated image portion Da2 identified in Step S3201.

Next, the combination unit 703 generates the third frame 730 by combination (Step S3204). Specifically, for example, as shown in FIG. 29, the combination unit 703 combines the second image region r2-60 of the frame F2-60, the copied image data of the first image region r3-30 (scenery), and the copied image data of the compensated image portion Db2 to thereby the frame F2-60 as the frame F2.

Thereafter, the processing returns to Step S2602. When the buffer does not have remaining frames (Step S2602: No), the combination unit 703 completes the image processing (Step S2507). This allows the combination unit 703 to generate the frame F2 causing a reduced sense of incongruity.

### Combination Example 3

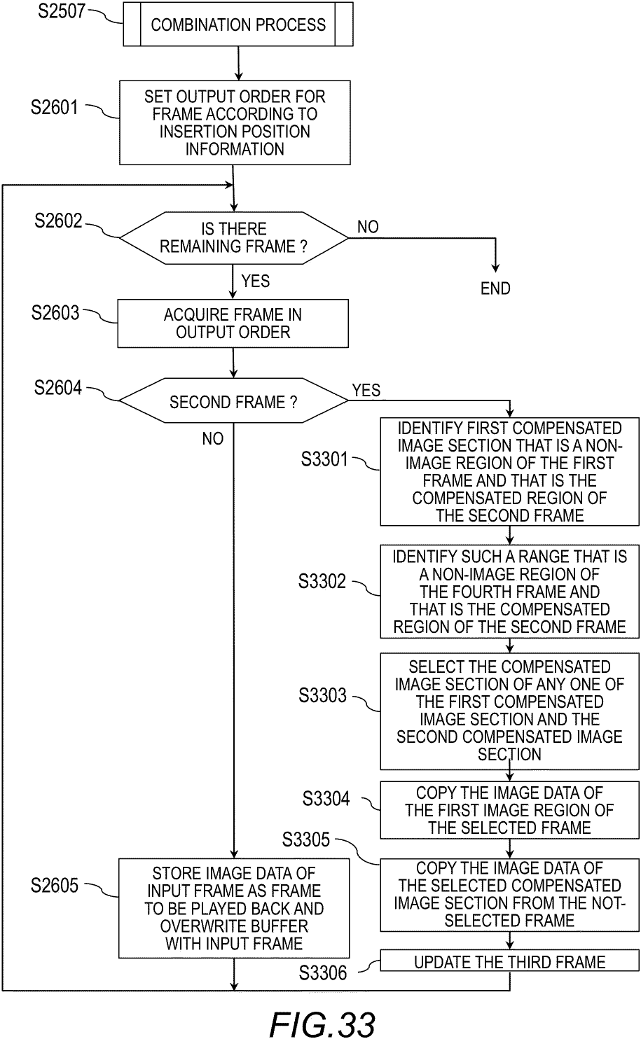

FIG. 33 is a flowchart illustrating the combination process procedure example 3 by the combination example 3 of the frame F2 by the combination unit 703. Steps that are the same as those in FIG. 26 are assigned the same step numbers and explanations thereof are omitted.

In step S2604, if the acquired frame is the second frame 713 (step S2604: Yes), then the identification unit 1240 identifies first range that is a non-image region in the first frame 711 and is the compensated region 712y in the second frame 713 (step S3301). Specifically, for example, as shown in FIG. 28, the identification unit 1240 identifies a compensated image portion Da1 in which a non-image region n1-60 of the frame F1-30 overlaps the compensated region 712y of the frame F2-60 in which a non-image region n2-30 was compensated.

The identification unit 1240 identifies the second range that is the non-image region of the fourth frame and the compensated region 712y of the second frame 713 (Step S3302). Specifically, for example, as shown in FIG. 29, the identification unit 1240 identifies the compensated image portion Da2 in which the non-image region n3-60 of the frame F3-30 and the compensated region 712y of the frame F2-60 compensated from the non-image region n2-30 are overlapped.

Next, the combination unit 703 selects any one of the identified first range or second range (Step S3303). Specifically, for example, the combination unit 703 selects a narrower range (or a range having a smaller area) from among the first range and the second range. The range selected by the combination unit 703 is called a selected range. In the case of the compensated image portions Da1 and Da2, the combination unit 703 selects the compensated image portion Da1. This can consequently minimize the range use for the combination, thus further suppressing the sense of incongruity.

Then, the combination unit 703 copies the image data of the first image region a1 of the selected frame (Step S3304). The selected frame is a frame based on which the selected range is identified. When the first range (the compensated image portion Da1) is selected for example, the selected frame is the first frame (frame F1). When the second range (the compensated image portion Da2) is selected, the selected frame is the fourth frame (frame F3).

Thus, the image data of the first image region a1 of the selected frame is the image data of the first image region r1-30 of the frame F1 (scenery) when the selected frame is the frame F1 and is the image data of the first image region r3-30 of the frame F3 (scenery) when the selected frame is the frame F3.

Then, the combination unit 703 copies the image data of the selected range of Step S3303 from the not-selected frame (Step S3106). The not-selected frame is a frame based on which the not-selected range is identified. When the first range (the compensated image portion Da1) is not selected for example, the not-selected frame is the first frame 711 (frame F1). When the second range (the compensated image portion Da2) is not selected, the not-selected frame is the fourth frame (frame F3). Thus, when the selected range is the compensated image portion Da1, the combination unit 703, copies, from the frame F3, the image data of the range Db1 at the same position as that of the compensated image portion Da1 and, when the selected range is the compensated image portion Da2, copies, from frame F1, the image data of the compensated image portion Db2 at the same position as that of the compensated image portion Da2.

Next, the combination unit 703 generates the third frame 730 (Step S3306). Specifically, for example, when the selected range is the first range (the compensated image portion Da1), the combination unit 703 combines the second image region r2-60 of the frame F2-60, the copied image data of the first image region r1-30 (scenery), and the copied image data of the compensated image portion Db1 to thereby update the frame F2-60 as the frame F2 (the third frame 730).

When the selected range is the second range (the compensated image portion Da2), the combination unit 703 combines the second image region r2-60 of the frame F2-60, the copied image data of the first image region r3-30 (scenery), and the copied image data of the compensated image portion Db2 to thereby update the frame F2-60 as the frame F2 (the third frame 730).

Thereafter, the process returns to Step S2602. When the buffer does not have remaining frames (Step S2602: No), the combination unit 703 completes the combination process (Step S2507). This allows the combination unit 703 to select a narrower range, thus minimizing the sense of incongruity due to the copying operation.

### Combination Example 4

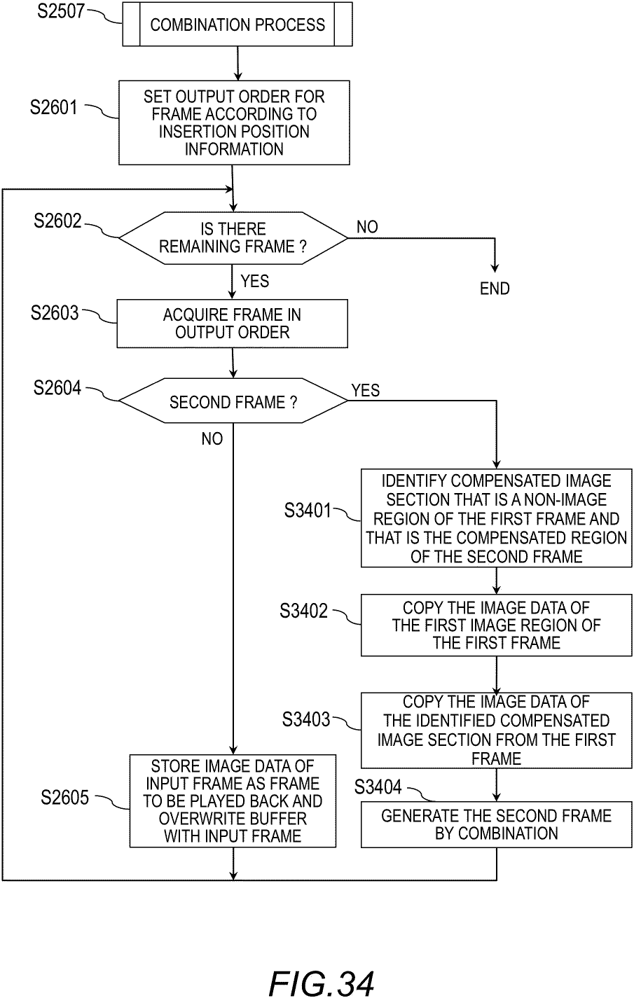

FIG. 34 is a flowchart illustrating the combination process procedure example 4 by the combination example 4 of the frame F2 by the combination unit 703. Steps that are the same as those in FIG. 26 are assigned the same step numbers and explanations thereof are omitted.

In step S2604, if the acquired frame is the second frame 713 (step S2604: Yes), then the identification unit 1240 identifies a range that is a non-image region in the first frame 711 and is the compensated region 712y in the second frame 713 (step S3401). Specifically, for example, as shown in FIG. 30, the combination unit 703 identifies a compensated image portion Da1 in which a non-image region n1-60 of the frame F1-30 overlaps the compensated region 712y of the frame F2-60 in which a non-image region n2-30 was compensated.

Next, the combination unit 703 copies the image data of the first image region a1 of the first frame 711 (Step S3402). Specifically, for example, the combination unit 703 copies the image data of the first image region r1-30 of the frame F1 (scenery).

Then, the combination unit 703 copies, from the first frame 711, the image data of the range identified in Step S3403 (Step S3204). Specifically, for example, the combination unit 703 copies, from frame F1, the image data of the same compensated image portion Db3 as the compensated image portion Da1 identified in Step S3401.

Next, the combination unit 703 generates the third frame 730 by combination (Step S3404). Specifically, for example, the combination unit 703 combines the second image region r2-60 of the frame F2-60, the copied image data of the first image region r1-30 (scenery), and the copied image data of the compensated image portion Db3 to thereby update the frame F2-60 as the frame F2 (the third frame 730).

Thereafter, the process returns to Step S2602. When the buffer does not have remaining frames (Step S2602: No), the combination unit 703 completes the combination process (Step S2507). This allows the combination unit 703 to generate the frame F2 causing a reduced sense of incongruity, as shown in FIG. 30.

8) Thus, the playback apparatus of 6) described in Embodiment 1 has the combination unit 703. If the second frame rate is selected, the combination unit 703 acquires the first video data 721 and the second video data 722 from the storage device 1202 and combines the first frame 711 with a second frame 713 temporally subsequent to the first frame 711 to generate the second frame 713, and generates a third frame 730 in which the image data of the first image region a1 in the first frame 711 is combined with the image data of the second image region a2 in the second frame 713.

In this manner, it is possible to mitigate loss of image data in the second frame 713 due to differences in frame rate. Thus, even if there were a difference in frame rate in one frame, it is possible to increase the reproducibility of the subject video by the third frame 730 and play back more realistic footage.

9) Also, in the playback apparatus of 8), for regions of the image data in the second image region a2 in the second frame 713 that overlap the image data of the first image region a1 in the first frame 711, the combination unit 703 uses the image data of the second image region a2 in the second frame 713 to generate the third frame 730.

As a result, in regions where the head section of the train in the frame F2-60 that is the second frame 713 overlaps the background region of the frame F1 that is the first frame 711, for example, the combination unit 703 prioritizes use of the head section of the train in the frame F2 that is the second frame 713. Thus, it is possible to attain an image with a more natural appearance (frame F2 that is the third frame 730), and it is possible to increase the reproducibility of the subject video as necessary and play back more realistic footage.

10) Also, in the playback apparatus of 8), for regions that belong to neither the second image region a2 in the second frame 713 nor the first image region a1 in the first frame 711, the combination unit 703 uses the image data of the second image region a2 in the first frame 711 to generate the third frame 730.

As a result, for an image region between the end portion of the train in the second frame of the frame F2-60 that is the second frame 713 and the background region of the frame F1 that is the first frame 711, for example, use of the image data of the second image region a2 (end of train) in the frame F1 that is the first frame 711 is prioritized. Thus, it is possible to attain a more natural image (frame F2 that is the third frame 730), and it is possible to increase the reproducibility of the subject video as necessary and play back more realistic footage.

11) Also, in the playback apparatus of 5), the identification unit 1240 identifies the compensated image portion Da1 that is the non-image region n1-60 corresponding to the second imaging region in the first frame 711 and that is the compensated region 712y in the second frame 713, on the basis of the first frame 711 and the second frame 713.

The combination unit 703 combines the image data of the second image region a2 in the second frame 713, the image data of the first image region a1 (r1-30) corresponding to the first imaging region of the first frame 711, and specific image data of the compensated image portion Da1 identified by the identification unit 1240 in another image region other than the image data of the first image region a1 (r1-30) of the first frame 711 and the image data of the second image region a2 in the second frame 713.

As a result, it is possible to compensate the non-image region n2-30 that was not outputted during imaging for the image data 712 with a frame that is close in time to the image data 712. Thus, it is possible to attain a combined frame with an even more natural appearance than the image data 712.

12) Furthermore, according to the above playback apparatus of 11), the first frame 711 is a frame generated temporally previous the second frame 713 (e.g., frame F1). The specific image data may be the image data of the range (Da1) in the first image region a1 (r1-30) of the frame (e.g., frame F3) generated temporally after to the second frame based on the outputs from the first imaging region and the second imaging region (i.e., the image data of the compensated image portion Db1).

Thus, the first frame 711 temporally previous to the second frame 713 and the third frame temporally after the second frame 713 can be interpolated to the non-image region n2-30 not imaged in the second frame 713. Thus, such a combined frame (the third frame 730) can be obtained that causes a lower sense of incongruity than the second frame.

Furthermore, according to the above playback apparatus of (3-11), the first frame 711 is a frame generated temporally after the second frame 713 (e.g., frame F3). The specific image data may be the image data of the range (Da2) in the first image region a1 (r1-30) of the frame (e.g., frame F1) generated temporally previous to the second frame 713 based on the outputs from the first imaging region and the second imaging region (i.e., the image data of the compensated image portion Db2).

As a result, it is possible to compensate the non-image region n2-30 that is the compensated region 712y of the second frame 713 with a first frame 711 that immediately precedes the second frame 713 and a fourth frame that immediately follows the second frame 713. Thus, it is possible to attain a combined frame with a natural appearance (third frame 730).

Furthermore, according to the above playback apparatus of (3-5), the identification unit 1240 identifies the range used by the combination unit 703 based on the first range (Da1) and the second range (Da2). The combination unit 703 combines the second frame 713, the image data of the first image region a1(r1-30/r3-30) in one frame (F1/F3) from which one range (Da1/Da2) among the first frame 711 and the fourth frame that is identified by the identification unit 1213 is identified and the image data (Db1/Db2) of one range (Da1/Da2) in the first image region a1(r3-30/r1-30) of the other frame (F3/F1) from which the other range (Da2/Da1) among the first frame 711 and the fourth frame that is not identified by the identification unit 1213 is identified.

This allows the combination unit 703 to select a narrower range, thus minimizing the sense of incongruity due to the copy operation.

Furthermore, according to the above playback apparatus of (3-5), the first frame 711 is a frame temporally generated prior to the second frame 713. The specific image data may be the image data of the range (Da1) in the second image region a2 of the first frame 711 (i.e., the image data of the compensated image portion Db3).

As a result, it is possible to compensate the non-image region n2-30 that is the compensated region 712y of the second frame 713 with a first frame 711 that immediately precedes the second frame 713. Thus, it is possible to attain a combined frame with a natural appearance (third frame 730).

### Embodiment 2

The following section will describe the illustrative embodiment 3. In the illustrative embodiment 1, in the frames F2, F4,... of FIG. 10, the compensated image portions Da1, Da3,... exist. Thus, the compensated image portions Da1, Da3 are painted with a specific color by the combination unit 703 or is subjected by the combination unit 703 to the demosaic process. In the illustrative embodiment 3, as in the illustrative embodiment 2, the combination unit 703 generates, without executing such an image process, the frames F2, F4,... that cause a lower sense of incongruity.

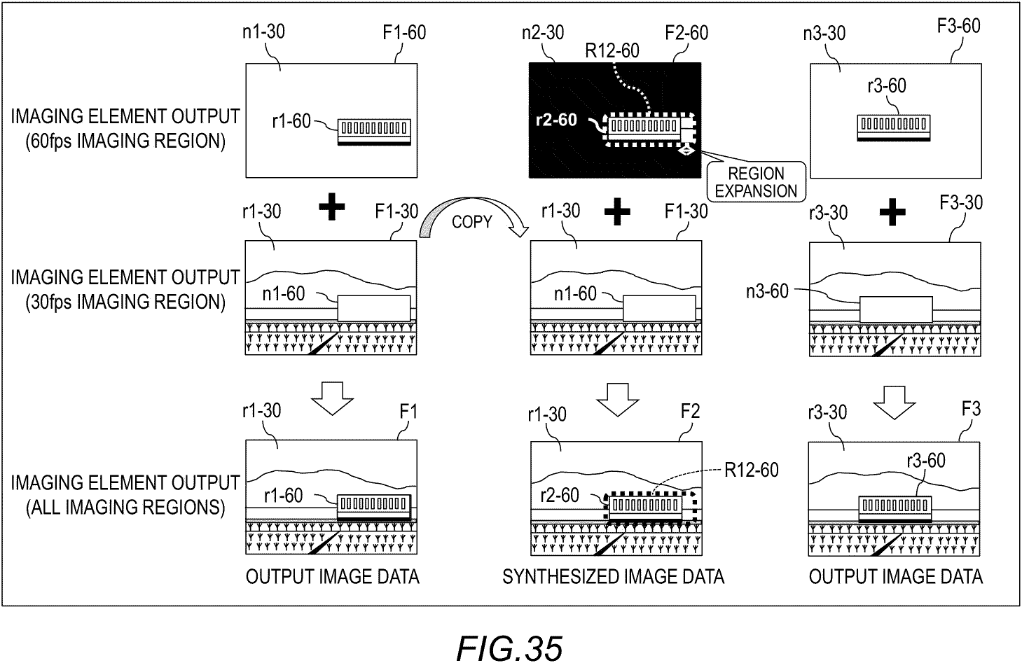

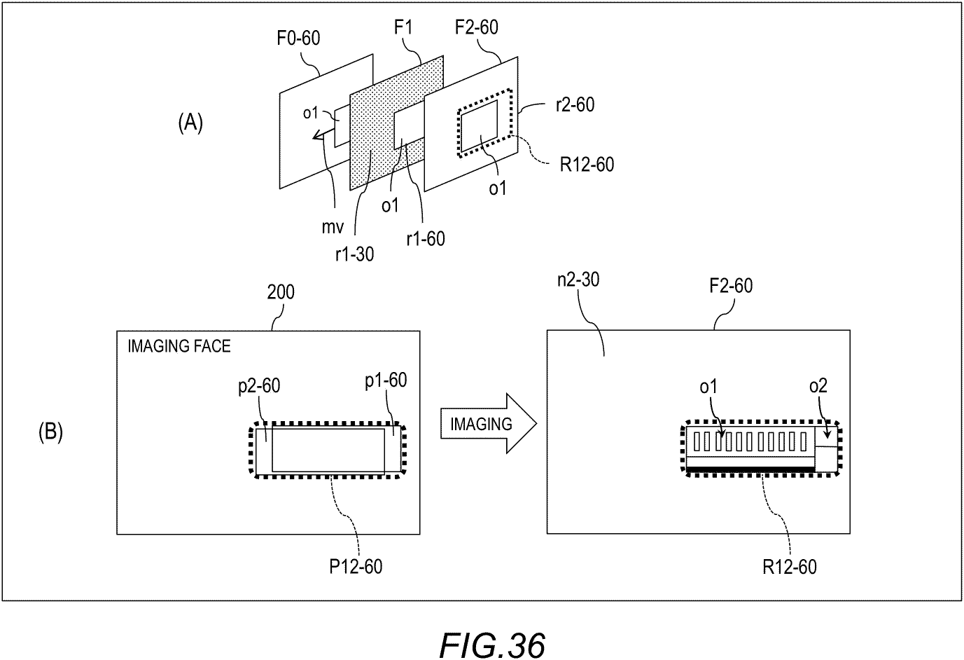

In Embodiment 3, components in common with Embodiment 1 and 2 are assigned the same reference characters and descriptions thereof are omitted. However, in FIGS. 35 and 36, black-filling by compensation is not shown in order to maintain visual clarity of the reference characters.

FIG. 35 illustrates the combination example of the frame F2 of 60[fps] according to the illustrative embodiment 3. Prior to the imaging of the frame F2-60, the preprocessing unit 1210 detects, from the frame F1 prior to the frame F2-60 for example, a specific subject such as a railway train and detects the motion vector of the specific subject in the previous frame F1. The preprocessing unit 1210 can use the image region of the specific subject of the frame F1 and the motion vector to obtain the image region R12-60 of 60[fps] in the next frame F2-60.

In the combination of the frame F2 as a combined frame, as in the illustrative embodiment 1, the combination unit 703 can copy the image data of the first image region r1-30 of the previous frame F1 (scenery) to combine the image data of the first image region r1-30 (scenery) and the image data of the image region R12-60 (the railway train and a part of the scenery) to thereby obtain the frame F2.

FIG. 36 illustrates the correspondence between the imaging region setting and the image region of the frame F2-60. (A) in FIG. 36 illustrates an example of the detection of a motion vector. (B) in FIG. 36 illustrates the correspondence between the imaging region setting and the image region of the frame F2-60.

The imaging region p1-60 is an imaging region of an already-detected specific subject that is obtained after the generation of the frame F0-60 temporally previous to the frame F1 and prior to the generation of the frame F1. Thus, the frame F1 has the image data o1 of the specific subject (railway train) existing in the second image region r1-60 corresponding to the imaging region p1-60.

The preprocessing unit 1210 causes the detection unit 1211 to detect the motion vector mv of the specific subject based on the image data o1 of the specific subject of the frame F0 and the image data o1 of the specific subject of the frame F1. Then, the preprocessing unit 1210 detects the second image region r2-60 of the next frame F2-60 in which the specific subject is displayed based on the second image region r1-60 of the specific subject of the frame F1 and the motion vector mv and detects the detection imaging region p2-60 of the imaging face 200 of the imaging element 100 corresponding to the detected second image region r2-60.

The preprocessing unit 1210 causes the setting unit 1212 to set, during the generation of the frame F1, the frame rate of the specific imaging region P12-60 including the identified imaging region p1-60 and the detection imaging region p2-60 as the second frame rate to output the setting instruction to the imaging element 100. This allows the imaging element 100 to set the specific imaging region P12-60 to the second frame rate and to generate the frame F2-60.

The first generation unit 701 compensates the image data 712 generated by imaging at the second frame rate set by the setting unit 1212 to output the second frame 713 (F2-60). In this case, the image data outputted from the specific imaging region P12-60 is the image data of the image region R12-60.

The combination unit 703 combines the image data of the first image region r1-30 included in the frame F1 with the image data (image region R12-60) from the specific imaging region P12-60 included in the second frame 713 (F2-60). As a result, the frame F2-60 is updated to the frame F2 (third frame 730).

It is noted that, after the generation of the frame F2-60 and prior to the generation of the next frame F3, the preprocessing unit 1210 sets the frame rate of the detection imaging region p2-60 to the second frame rate and sets the frame rates of other imaging regions other than the detection imaging region p2-60 of the imaging face 200 to the first frame rate.

This allows, in the generation of the frame F3 obtained through the imaging operation including the imaging region of the first frame rate, the second imaging region in which the second frame rate is set is detection imaging region p2-60 only as in the frame F1. This allows the specific detection imaging region to be set for the frames F2-60, F4-60,... as a combination target, thus suppressing the wasteful processing in the frames F1, F3,....

The frame F2-60 is configured so that the image region R12-60 includes the image data o1 of the specific subject (railway train) and the image data o2 of a part of the scenery. In this manner, the image region R12-60 is configured, when compared with the second image region r2-60, so as to be expanded at the opposite side to the direction along which the specific subject moves. Thus, there is no need as in the illustrative embodiment 2 to identify the compensated image portions Da1 and Da2 to copy and combine the image data of the compensated image portions Db 1 and Db2 of other frames. It is noted that the combination process of the illustrative embodiment 3 is executed in Step S2507 of FIG. 25 for example. This combination process is applied to the combination of the frames F2-60, F4-60,... having the second frame rate only and is not executed for the frames F1, F3,... including the image region of the first frame rate.

As described above, in the illustrative embodiment 3, the image data as a combination source is composed of two image regions of the image region R12-60 and the first image region r1-30 of the frame F1 in the second frame 713. Thus, the frame F2 causing a lower sense of incongruity can be generated. Specifically, the pieces of image data o1 and o2 are image data imaged at the same timing. Thus, the pieces of image data o1 and o2 have therebetween a boundary that is not unnatural and that causes no sense of incongruity. Furthermore, the illustrative embodiment 3 does not require the processing as in the illustrative embodiment 2 to identify the compensated image portions Da1 and Da2 and to select an optimal range from among the compensated image portions Da1 and Da2. This can consequently reduce the combination process load on the frame F2.

1) As described above, the imaging apparatus according to the illustrative embodiment 3 has the imaging element 100, the detection unit 1211, and the setting unit 1212. The imaging element 100 has the first imaging region to image a subject and the second imaging region to image a subject. The first imaging region can have the first frame rate (e.g., 30[fps]) and the second imaging region can have the second frame rate higher than the first frame rate (e.g., 60[fps]).

The detection unit 1211 detects the detection imaging region p2-60 of the specific subject in the imaging element 100 based on the second image region r1-60 of the specific subject included in the frame F1 generated based on the output from the imaging element 100. The setting unit 1212 sets, as the second frame rate, the frame rate of the specific imaging region P12-60 that includes the imaging region p1-60 of the specific subject used for the generation of the frame F1 and the imaging region detected by the detection unit 1211 (hereinafter referred to as detection imaging region) p2-60.

Thus, the imaging region of the second frame rate can be set in an expanded manner in such a manner that the specific subject can be imaged at the second frame rate so that the frames F1 and F2 do not have the compensated image portion Da1 in which non-image regions are overlapped, thus providing the suppression of the missing image of the frame F2-60 imaged at the second frame rate.

2) Furthermore, in the above 1) imaging apparatus, the detection unit 1211 detects the detection imaging region p2-60 of the specific subject based on the second image region r1-60 of the specific subject included in the frame F1 and the motion vector mv of the specific subject between the frame F1 and the frame F0-60 temporally previous to the frame F1.

This can realize the prediction of the detection imaging region p2-60 of the specific subject in an easy manner.

3) Furthermore, in the above 1) imaging apparatus, the setting unit 1212 is configured, when the frame is the first frame F1 generated based on the output from the first imaging region, to set the frame rate of the specific imaging region to the second frame rate and to set, when the frame is the second frame F2-60 that is generated after the first frame F1 based on the output from the specific imaging region, the frame rate of the detection imaging region p2-60 to the second frame rate and to set the frame rates of imaging regions other than the detection imaging region p2-60 (a part of the imaging face 200 excluding the detection imaging region p2-60) to the first frame rate.

As a result, the specific detection imaging region only for the frames F2-60, F4-60,... as a combination target is set, thus suppressing the wasteful processing for the frames F1, F3,....

4) Furthermore, the image processing apparatus according to the illustrative embodiment 3 execute the image processing on the frame generated based on the output from the imaging element 100 that has the first imaging region to image a subject and the second imaging region to image a subject and for which the first frame rate (e.g., 30[fps]) can be set for the first imaging region and the second frame rate higher than the first frame rate (e.g., 60[fps]) can be set for the second imaging region.

This image processing apparatus has the detection unit 1211, the setting unit 1212, the first generation unit 701, and the combination unit 703. The detection unit 1211 detects the imaging region p2-60 of the specific subject in the imaging element 100 based on the second image region r1-60 of the specific subject included in the frame F1 generated based on the output from the imaging element 100. The setting unit 1212 sets the frame rate of the specific imaging region P12-60 including the imaging region p1-60 of the specific subject used for the generation of the frame F1 and the detection imaging region p2-60 detected by the detection unit 1211 to the second frame rate.

The first generation unit 701 compensates the image data 712 generated by imaging at the second frame rate set by the setting unit 1212 to output the second frame 713 (F2-60).

The combination unit 703 combines the image data of the first image region r1-30 included in the first frame F1 and the image data from the specific imaging region P12-60 included in the second frame 713 (F2-60) (image region R12-60).

Thus, the imaging region of the second frame rate can be set in an expanded manner such that the specific subject can be imaged at the second frame rate so that the frames F1 and F2 do not have the compensated image portion Da1 in which non-image regions are overlapped, thus providing the suppression of the missing image of the frame F2-60 imaged at the second frame rate. Furthermore, the interpolation of the overlapped compensated image portion Da1 during the combination is not required, thus providing an image causing a lower sense of incongruity. Furthermore, the combination processing load also can be reduced.

The present invention is not limited to the content above, and the content above may be freely combined. Also, other aspects considered to be within the scope of the technical concept of the present invention are included in the scope of the present invention.

### EXPLANATION OF REFERENCES

100 imaging element, 701 first generation unit, 702 compression/decompression unit, 703 combination unit, 704 playback unit, 800 video file, 801 header portion, 802 data portion, 835 additional information, 910 imaging condition information, 911 frame rate information, 912 position information, 920 insertion position information, 921 insertion frame number, 922 insertion destination, 1201 processor, 1202 storage device, 1210 preprocessing unit, 1211 detection unit, 1212 setting unit, 1220 acquisition unit, 1231 compression unit, 1232 generation unit, 1233 selection unit, 1234 decompression unit, 1240 identification unit

What is claimed is:

1. A video compression apparatus configured to compress a plurality of frames outputted from an imaging element that has a plurality of imaging regions in which a subject is captured and that can set imaging conditions for each of the imaging regions, the video compression apparatus comprising:
an acquisition unit configured to acquire data outputted from a first imaging region in which a first frame rate is set and data outputted from a second imaging region in which a second frame rate is set;
a generation unit configured to generate a plurality of first frames on the basis of the data outputted from the first imaging region acquired by the acquisition unit and generate a plurality of second frames on the basis of the data outputted from the second imaging region; and
a compression unit configured to compress the plurality of first frames generated by the generation unit and compress the plurality of second frames.

2. The video compression apparatus according to claim 1,
wherein the generation unit is configured to generate the first frames on the basis of the data outputted from the first imaging region and the data outputted from the second imaging region.

3. The video compression apparatus according to claim 1,
wherein the generation unit is configured to generate the second frames on the basis of the data outputted from the second imaging region and data not based on output from the imaging element.

4. The video compression apparatus according to claim 3,
wherein the generation unit is configured to generate the second frames on the basis of the data outputted from the second imaging region and prescribed data.

5. The video compression apparatus according to claim 4,
wherein the generation unit is configured to generate the second frames by compensating a region where data from the first imaging region was not outputted for the data outputted from the second imaging region.

6. The video compression apparatus according to claim 5,
wherein the generation unit is configured to generate the second frames by compensating the region where data from the first imaging region was not outputted with a specific color for the data outputted from the second imaging region.

7. The video compression apparatus according to claim 3, further comprising:
a detection unit configured to detect motion vectors for image data in a region generated on the basis of the data outputted from the second imaging region among the second frames.

8. The video compression apparatus according to claim 7,
wherein the detection unit is configured not to detect motion vectors for image data in a region other than a region generated on the basis of the data outputted from the second imaging region.

9. The video compression apparatus according to claim 7, further comprising:
a motion compensation unit configured to execute motion compensation on the basis of detection results of the detection unit.

10. An electronic apparatus, comprising:
an imaging element having a plurality of imaging regions in which a subject is captured, and that can set imaging conditions for each of the imaging regions;
an acquisition unit configured to acquire data outputted from a first imaging region in which a first frame rate is set and data outputted from a second imaging region in which a second frame rate is set;
a generation unit configured to generate a plurality of first frames on the basis of the data outputted from the first imaging region acquired by the acquisition unit and generate a plurality of second frames on the basis of the data outputted from the second imaging region; and
a compression unit configured to compress the plurality of first frames generated by the generation unit and compress the plurality of second frames.

11. A video compression program that causes a processor to execute compression of a plurality of frames outputted from an imaging element that has a plurality of imaging regions in which a subject is captured and that can set imaging conditions for each of the imaging regions,
wherein said program causes the processor to execute:
an acquisition process of acquiring data outputted from a first imaging region in which a first frame rate is set and data outputted from a second imaging region in which a second frame rate is set;
a generation process of generating a plurality of first frames on the basis of the data outputted from the first imaging region acquired in the acquisition process and generating a plurality of second frames on the basis of the data outputted from the second imaging region; and
a compression process of compressing the plurality of first frames generated in the generation process and compressing the plurality of second frames.
